(19) United States
(12) Patent Application Publication
(10) Pub. No.: US 2015/0220875 A1
(43) Pub. Date: Aug. 6, 2015

(54) METHOD AND SYSTEM OF MANAGING REPLACEMENT TIMING INTERVAL OF MAINTENANCE PART

(71) Applicants: Kenji Tamaki, Tokyo (JP); Jun Tateishi, Tokyo (JP)

(72) Inventors: Kenji Tamaki, Tokyo (JP); Jun Tateishi, Tokyo (JP)

(73) Assignee: HITACHI, LTD., Chiyoda-Ku, Tokyo (JP)

(21) Appl. No.: 14/406,268

(22) PCT Filed: Jun. 13, 2012
(86) PCT No.: PCT/JP2012/065142

§ 371 Date: Dec. 8, 2014

(51) Int. Cl. G06Q 10/08; G06Q 10/06

(52) U.S. Cl. CPC G06Q 10/087; G06Q 10/06313

(57) ABSTRACT

In a maintenance-part replacement timing interval management system 100, a machine working time information collection unit 107, a maintenance-part supply history information collection unit 109, a machine-basis demand forecast unit 102, an area-basis demand forecast unit 103, a demand-supply gap calculation unit 104, a replacement timing interval update unit 105, etc. are provided, so that a demand forecast simulation is performed by collecting the working time of each of a plurality of machines worked in target areas where machine working conditions are similar to each other, by collecting an accumulated total number of the actual maintenance-part supply of a maintenance part for the target area, by calculating the past part replacement timing of each of the machines in the target area from the maintenance-part replacement timing interval for which a tentative value is previously determined and from the working time, and by counting an accumulated total number of past maintenance-part replacement demand of all the machines in time series, and a maintenance-part demand-supply gap value which is the difference between the time-series accumulated total number of maintenance-part replacement demand and the accumulated total number of maintenance-part supply is calculated, an optimum estimation value of the maintenance-part replacement timing interval which minimizes the maintenance-part demand-supply gap value is calculated while changing the tentative value of the maintenance-part replacement timing interval, and a future demand for the maintenance part is forecasted by using the optimum estimation value of the maintenance-part replacement timing interval.

### TECHNICAL FIELD

The present invention relates to a method and a system of managing a replacement timing interval of a maintenance part.

### BACKGROUND ART

As background techniques of the present technical field, for example, Japanese Patent No. 4593055 (Patent Document 1), Japanese Patent Application Laid-Open Publication No. 2005-173979 (Patent Document 2) and Japanese Patent No. 4884214 (Patent Document 3) are cited.

The above-described Patent Document 1 describes a technique and others as follows. “The working time of each of engines, fronts, turning bodies, and traveling bodies of hydraulic shovels worked in a market is measured, and the data of the working time is memorized in a memory of a controller, and then, is transferred to a base-station computer via satellite communication, FD, or others, and is memorized in a database. The base-station computer calculates the working-time-based replacement timing interval of the part for each section related to the part by using the working data at every time of repair/replacement of a part of each hydraulic shovel, and memorizes and accumulates the replacement timing interval, and besides, reads the data for each hydraulic shovel, acquires a replacement rate of the part having the almost same replacement timing interval for each part, and calculates a target replacement timing interval of the part based on the replacement timing interval corresponding to a maximum replacement rate. In this manner, an appropriate target replacement timing interval can be set, and appropriate replacement scheduled time can be determined even for a part related to a section having different working time.”

Also, the above-described Patent Document 2 describes a technique and others as follows. “The error information or alarm information sent from a construction machine is acquired by a server. A replaceability judging means of the server determines a working area of the construction machine from position information memorized in position-information database, and reads the load (life of a part in the working area) applied to the part in the working area from a working-environment-load database. Then, the replaceability judging means determines that the part for which the error information or alarm information has been sent becomes a replacement target with a resupplying part if the part for which the error information or the alarm information has been sent has reached life in the working area and the total working time of the construction machine has become predetermined working time or longer or if the number of times of sending the error information has become a predetermined number or longer or the sending continued time of the alarm information has become predetermined time or longer.”

Moreover, the above-described Patent Document 3 describes a technique and others as follow. “This invention provides a maintenance supporting system of a construction machine capable of accurately planning a maintenance plan of a part. This system simulates an operation/working situation of the construction machine based on production working conditions by an operation simulation means, and then, calculates the accumulated load of each part depending on the operation/working situation by a load calculating means, and forecasts the life of each part based on the accumulated load by a life calculating means. Therefore, a maintenance plan can be planned with higher accuracy than that of a conventional technique of determining which part is to be maintained based on simply the working time. Therefore, a risk of occurrence of sudden part abnormality can be reduced at an earlier stage than the planned life.”

### PRIOR ART DOCUMENTS

### Patent Documents

Patent Document 1: Japanese Patent No. 4593055

Patent Document 2: Japanese Patent Application Laid-Open Publication No. 2005-173979

Patent Document 3: Japanese Patent No. 4884214

### SUMMARY OF THE INVENTION

### Problems to be Solved by the Invention

Incidentally, as a result of the study on the conventional techniques of managing the replacement timing interval of the maintenance part including the above-described Patent Documents 1 to 3 by the present inventors, the following has been found out.

For example, the maintenance part is periodically replaced for a machine provided with a maintenance part which deteriorates with age due to wearing or others as a component. In a machine manufacturing company, in order to supply the maintenance part to a machine operating company without delay, it is required to forecast the demand based on the time interval of the periodic replacement, and manage the appropriate stock. Generally, the time interval of the maintenance-part replacement performed in the machine operating company cannot be recognized from the machine manufacturing company, and therefore, the working time of the machine is monitored, and the maintenance-part replacement timing interval is estimated based on designed life, so that the demand is forecasted as described in the above-described Patent Document 1. Moreover, it is attempted that the estimation accuracy of the replacement timing interval of each maintenance part is improved by monitoring sensor alarm information as described in the above-described Patent Document 2 or by monitoring the accumulated load as described in the above-described Patent Document 3.

However, since the speed of time-dependent deterioration of the maintenance part is changed depending on the use environment or use method of the machine, the machine operating company sets a unique replacement timing interval for the management. Therefore, the estimation of the maintenance-part replacement timing interval based on the designed life causes an error in the demand forecasting, and there has been a problem that safety stock cost for supplying the maintenance part without delay is increased. Even if the sensor alarm information or accumulated load related to each maintenance part is monitored, this does not always match the management value of the time interval of unique periodic replacement of the machine operating company, and therefore, there has been a problem that accuracy is not enough in the application to the demand forecasting.

As described above, in order to forecast the demand of the maintenance part with the highly accuracy, the conventional techniques of managing the replacement timing interval of the maintenance part have a problem to estimate the maintenance-part replacement timing interval of the machine operating company.

Accordingly, the present invention has been made in consideration of such problems of the conventional techniques, and a typical object thereof is to provide a method and a system of managing a replacement timing interval of a maintenance part that can estimate the replacement timing interval of the maintenance part of the machine operating company and can forecast demand of the maintenance part with the high accuracy based on the estimation value on the side of the machine manufacturing company.

The above and other object and novel characteristics of the present invention will be apparent from the description of the present specification and the accompanying drawings.

### Means for Solving the Problems

The typical summary of the inventions disclosed in the present application will be briefly described as follows.

That is, a typical method of managing a replacement timing interval of a maintenance part is a method of managing a replacement timing interval of a maintenance part that forecasts, by a management system using a calculator, the demand for a maintenance part of a machine having the maintenance part as a component, which is periodically replaced due to time-dependent deterioration, and has the following characteristics.

The method of managing the replacement timing interval of the maintenance part has: a machine working-time information collection step of collecting working time of each of a plurality of machines worked in target areas where machine working conditions are similar to each other and of memorizing the working time in a machine working-time information memory unit; a maintenance-part supply history information collection step of collecting an accumulated total number of the actual maintenance-part supply of the maintenance part to the target area and of memorizing the accumulated total number in a maintenance-part supply history information memory unit; a demand forecast simulation step of calculating past part replacement timing of each machine in the target area from a maintenance-part replacement timing interval for which a tentative value is previously determined and from the working time memorized in the machine working-time information memory unit, and of counting and outputting an accumulated total number of past maintenance-part replacement demands of all the machines in time series; a maintenance-part demand-supply gap calculation step of calculating and outputting a maintenance-part demand-supply gap value which is the difference between the time-series accumulated total number of maintenance-part replacement demand output in the demand forecast simulation step and the accumulated total number of the maintenance-part supply memorized in the maintenance-part supply history information memory unit; and a maintenance-part replacement timing interval update step of calculating and outputting an optimum estimation value of the maintenance-part replacement timing interval which minimizes the maintenance-part demand-supply gap value output in the maintenance-part demand-supply gap calculation step while changing a tentative value of the maintenance-part replacement timing interval. Then, the method has a feature that the future demand for the maintenance part is forecasted by using the optimum estimation value of the maintenance-part replacement timing interval output in the maintenance-part replacement timing interval update step.

Moreover, a typical system of managing a replacement timing interval of a maintenance part is a system of managing the replacement timing interval of the maintenance part that forecasts, by a management system using a calculator, the demand for the maintenance part of a machine having the maintenance part as a component, which is periodically replaced due to time-dependent deterioration, and has the following feature.

The system of managing the replacement timing interval of the maintenance part has: a machine working time information collection unit that collects working time of each of a plurality of machines worked in target areas where machine operation conditions are similar to each other, and memorizes the working time in a machine working time information memory unit; a maintenance-part supply history information collection unit that collects an accumulated total number of the actual maintenance-part supply of the maintenance part for the target area and memorizes the accumulated total number in a maintenance-part supply history information memory unit; a demand forecast simulator unit that calculates past part replacement timing of each machine in the target area from a maintenance-part replacement timing interval for which a tentative value is previously determined and the working time memorized in the machine working time information memory unit, and counts and outputs an accumulated total number of the past maintenance-part replacement demand of all the machines in time series; a maintenance-part demand-supply gap calculation unit that calculates and outputs a maintenance-part demand-supply gap value which is the difference between the time-series accumulated total number of maintenance-part replacement demand output from the demand forecast simulator unit and the accumulated total number of maintenance-part supply memorized in the maintenance-part supply history information memory unit; and a maintenance-part replacement timing interval update unit that calculates and outputs an optimum estimation value of the maintenance-part replacement timing interval which minimizes the maintenance-part demand-supply gap value output from the maintenance-part demand-supply gap calculation unit while changing the tentative value of the maintenance-part replacement timing interval. Then, the system has a feature that the future demand for the maintenance part is forecasted by using the optimum estimation value of the maintenance-part replacement timing interval output from the maintenance-part replacement timing interval update unit.

### Effects of the Invention

The effects obtained by typical aspects of the present invention disclosed in the present application will be briefly described below.

That is, a typical effect can provide the method and the system of managing the replacement timing interval of the maintenance part that can estimate the replacement timing interval of the maintenance part of a machine operating company and can forecast the demand for the maintenance part with a high accuracy based on the estimation value on the side of the machine manufacturing company.

### BRIEF DESCRIPTIONS OF THE DRAWINGS

FIG. 1 is a configuration diagram showing an example of a maintenance-parts supply network including a maintenance-part replacement timing interval managing system of a first embodiment of the present invention;

FIG. 2 is a configuration diagram showing an example of the maintenance-part replacement timing interval managing system shown in FIG. 1;

FIG. 3 is a flowchart showing an example of a processing procedure of the maintenance-part replacement timing interval managing system shown in FIG. 2;

FIG. 4 is a detailed flowchart showing an example of a demand forecast simulation in the processing procedure of the maintenance-part replacement timing interval managing system shown in FIG. 3;

FIG. 5 is an explanatory diagram showing an example of a simulation of a machine-basis replacement event of the maintenance part in the processing procedure of the maintenance-part replacement timing interval managing system shown in FIG. 3;

FIG. 6 is an explanatory diagram showing an example of a simulation of a machine-basis replacement event of the maintenance part, continued from FIG. 5;

FIG. 7 is an explanatory diagram showing an example of a simulation of a machine-basis replacement event of the maintenance part, continued from FIG. 6;

FIG. 8 is an explanatory diagram showing an example of a simulation of a machine-basis replacement event of the maintenance part, continued from FIG. 7;

FIG. 9 is an explanatory diagram showing an example of a simulation of a machine-basis replacement event of the maintenance part, continued from FIG. 8;

FIG. 10 is a configuration diagram showing an example of a calculator system of a machine-manufacturing-company operation center in the first embodiment of the present invention;

FIG. 11 is an explanatory drawing showing an example of maintenance-part supply history information in the maintenance-part replacement timing interval managing system shown in FIG. 2;

FIG. 12 is an explanatory diagram showing an example of machine working time information in the maintenance-part replacement timing interval managing system shown in FIG. 2;

FIG. 13 is an explanatory diagram showing an example of an area-name list in the maintenance-part replacement timing interval managing system shown in FIG. 2;

FIG. 14 is an explanatory diagram showing an example of a part list in the maintenance-part replacement timing interval managing system shown in FIG. 2;

FIG. 15 is an explanatory diagram showing an example of a machine list in the maintenance-part replacement timing interval managing system shown in FIG. 2;

FIG. 16 is an explanatory diagram showing an example of a replacement timing interval list in the maintenance-part replacement timing interval managing system shown in FIG. 2;

FIG. 17 is an explanatory diagram showing an example of a batch calculation screen of a screen interface in the maintenance-part replacement timing interval managing system shown in FIG. 2;

FIG. 18 is an explanatory diagram showing an example of a result display screen of the screen interface in the maintenance-part replacement timing interval managing system shown in FIG. 2;

FIG. 19 is an explanatory diagram showing an example of a demand forecast screen of the screen interface in the maintenance-part replacement timing interval managing system shown in FIG. 2;

FIG. 20 is a flowchart showing an example of a processing procedure of a maintenance-part replacement timing interval managing system of a second embodiment of the present invention;

FIG. 21 is a detailed flowchart showing an example of a demand forecast simulation in the processing procedure of the maintenance-part replacement timing interval managing system shown in FIG. 20; and

FIG. 22 is an explanatory diagram showing an example of a replacement timing interval list in the maintenance-part replacement timing interval managing system of the second embodiment of the present invention.

### BEST MODE FOR CARRYING OUT THE INVENTION

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

### SUMMARY OF EMBODIMENT OF PRESENT INVENTION

A method of managing a replacement timing interval of a maintenance part of an embodiment of the present invention is a method of managing a replacement timing interval of a maintenance part that forecasts, by a management system using a calculator, the demand for the maintenance part of a machine including the maintenance part as a component, which is periodically replaced due to time-dependent deterioration, and has the following feature. (As an example, a reference symbol of the corresponding component is additionally described in parentheses “( )”).

The method of managing the replacement timing interval of the maintenance part has: a machine working time information collection step (305) of collecting working time of each of a plurality of machines worked in target areas where machine working conditions are similar to each other, and memorizing the working time in a machine working time information memory unit; a maintenance-part supply history information collection step (206) of collecting an accumulated total number of the actual maintenance-part supply of the maintenance part to the target area, and memorizing the accumulated total number in a maintenance-part supply history information memory unit; a demand forecast simulation step (300) of calculating past part replacement timing of each machine in the target area from a maintenance-part replacement timing interval for which a tentative value is previously determined and the working time memorized in the machine working time information memory unit, and of counting and outputting an accumulated total number of past maintenance-part replacement demand of all the machines in time series; a maintenance-part demand-supply gap calculation step (207) of calculating and outputting a maintenance-part demand-supply gap value which is the difference between the time-series accumulated total number of maintenance-part replacement demand output in the demand forecast simulation step and the accumulated total number of maintenance-part supply memorized in the maintenance-part supply history information memory unit; and a maintenance-part replacement timing interval update step (208) of calculating and outputting an optimum estimation value of the maintenance-part replacement timing interval which minimizes the maintenance-part demand-supply gap value output in the maintenance-part demand-supply gap calculation step while changing the tentative value of the maintenance-part replacement timing interval. Then, the method has a feature that the future demand for the maintenance part is forecasted by using the optimum estimation value of the maintenance-part replacement timing interval output in the maintenance-part replacement timing interval update step.

A system of managing a replacement timing interval of a maintenance part of an embodiment of the present invention is a system of managing the replacement timing interval of the maintenance part that forecasts, by a management system using a calculator, the demand for the maintenance part of a machine including the maintenance part as a component, which is periodically replaced due to time-dependent deterioration, and has the following feature (as an example, a symbol of the corresponding component or others is additionally described in parentheses “( )”).

The system of managing the replacement timing interval of the maintenance part has: a machine working time information collection unit (107) that collects working time of each of a plurality of machines worked in target areas where machine operation conditions are similar to each other and memorizes the working time in a machine working time information memory unit; a maintenance-part supply history information collection unit (109) that collects an accumulated total number of the actual maintenance-part supply of the maintenance part for the target area and memorizes the accumulated total number in a maintenance-part supply history information memory unit; a demand forecast simulator unit (102, 103) that calculates past part replacement timing of each machine in the target area from a maintenance-part replacement timing interval for which a tentative value is previously determined and the working time memorized in the machine working time information memory unit and counts and outputs an accumulated total number of the past maintenance-part replacement demand of all the machines in time series; a maintenance-part demand-supply gap calculation unit (104) that calculates and outputs a maintenance-part demand-supply gap value which is the difference between the time-series accumulated total number of maintenance-part replacement demand output from the demand forecast simulator unit and the accumulated total number of maintenance-part supply memorized in the maintenance-part supply history information memory unit; and a maintenance-part replacement timing interval update unit (105) that calculates and outputs an optimum estimation value of the maintenance-part replacement timing interval which minimizes the maintenance-part demand-supply gap value output from the maintenance-part demand-supply gap calculation unit while changing the tentative value of the maintenance-part replacement timing interval. Then, the system has a feature that the future demand for the maintenance part is forecasted by using the optimum estimation value of the maintenance-part replacement timing interval output from the maintenance-part replacement timing interval update unit.

Each embodiment based on the summary of the embodiments of the present invention described above will be described in detail below based on drawings. Note that the same components are denoted by the same reference symbols throughout all of the drawings for describing the embodiments, and the repetitive description thereof will be omitted.

### First Embodiment

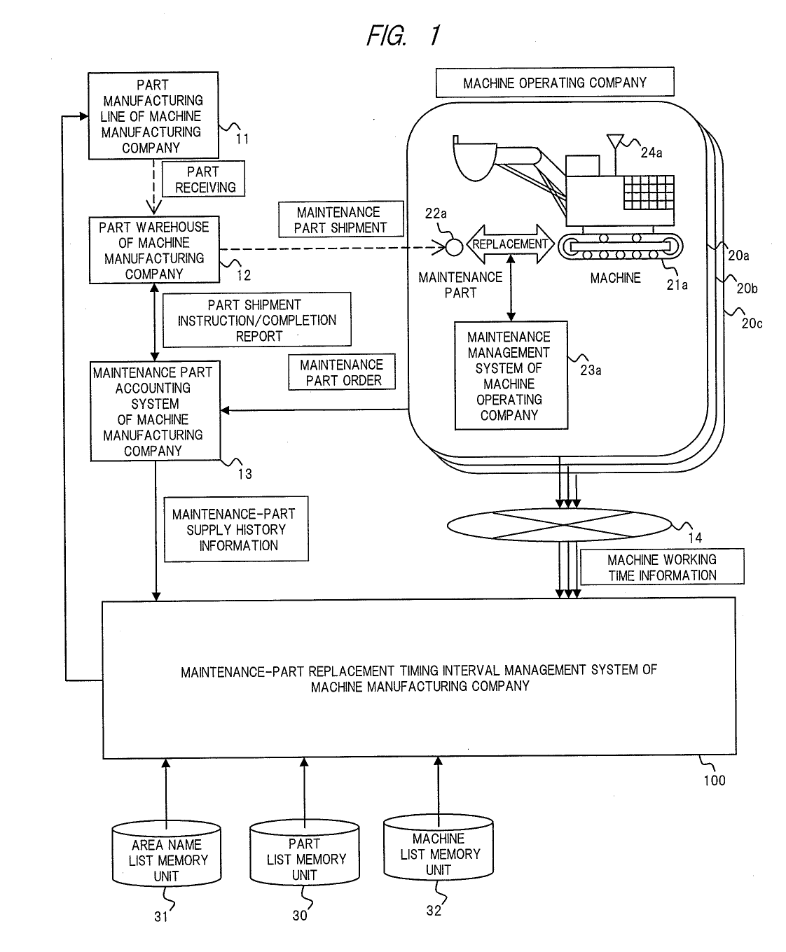

A method and a system of managing a replacement time interval of a maintenance part of a first embodiment will be explained by using FIG. 1 to FIG. 19.

The present invention relates to a method and a system of managing a replacement time interval of a maintenance part which is generally applicable to mechanical equipment including a part which temporally becomes worn or degrades. In the present embodiment, a target machine is not limited to manufacturing equipment of electronic devices, manufacturing equipment of semiconductors, medical devices, electricity generators, electric motors, electric trains, locomotives, automobiles, construction machines, and others, and this is described as a machine(s).

In the present embodiment, as the target areas where the machine operation conditions are similar to each other, although the target areas sorted by similar environments are exemplified for the explanation, the areas are not limited thereto. The target areas sorted by similar intended uses or the target areas sorted by machine operating companies are also applicable.

<Configuration of Maintenance-Part Supply Network Including Maintenance-Part Replacement Timing Interval Managing System>

FIG. 1 is a configuration diagram showing an example of a maintenance-part supply network including the maintenance-part replacement timing interval managing system of the present embodiment. In FIG. 1, a solid line shows transmission/reception of information related to a maintenance part, and a broken line shows movement of the maintenance part.

As shown in FIG. 1, the maintenance-part supply network is configured of each systems on a machine manufacturing company side and each system on a side of a plurality of machine operating companies 20a, 20b, and 20c (in some cases, simply described as 20). The machine manufacturing company side is provided with a part manufacturing line 11, a part warehouse 12, a maintenance-part accounting system 13, and a maintenance-part replacement timing interval management system 100. To the maintenance-part replacement timing interval management system 100, a part list memory unit 30, an area-name list memory unit 31, a machine list memory unit 32 are connected.

On the side of the machine operating companies 20a, 20b, and 20c, for example, the machine operating company 20a side has a machine 21a, and is provided with a maintenance management system 23a for managing replacement of a maintenance part 22a of the machine 21a. The machine 21a is provided with a communication unit 24a. Although not shown in the drawing, other side of the machine operating companies 20b and 20c similarly has machines (21b, 21c) provided with communication units (24b, 24c), and are provided with maintenance management systems (23b, 23c) for managing replacement of the maintenance parts of the machines, respectively. Each system on the side of the machine operating companies 20a, 20b, and 20c is connected to the maintenance-part replacement timing interval management system 100 of the machine manufacturing company via a network 14.

In the maintenance-part supply network configured as described above, for example, supply of the maintenance part 22a is performed in such an order as receiving from the part manufacturing line 11 of the machine manufacturing company to the part warehouse 12 of the machine manufacturing company, and then, shipment from the part warehouse 12 to the machine operating company 20a.

The information related to supply of the maintenance part 22a is performed in a flow of a maintenance-part order sent from the machine operating company 20a to the maintenance-part accounting system 13 of the machine manufacturing company, a part shipment instruction sent from the maintenance-part accounting system 13 to the part warehouse 12, and a part shipment completion report sent from the part warehouse 12 to the maintenance-part accounting system 13. The maintenance-part supply history information managed by the maintenance-part accounting system 13 is sent to the maintenance-part replacement timing interval management system 100 of the machine manufacturing company.

The maintenance part 22a for the machine 21a owned by the machine operating company 20a is replaced by an instruction of the maintenance management system 23a of the machine operating company, and actual performance information such as replacement date is also recorded in the maintenance management system 23a. The maintenance management system 23a of the machine operating company is not connected to the maintenance-part accounting system 13 or the maintenance-part replacement timing interval management system 100 of the machine manufacturing company.

On the other hand, the machine 21a is provided with the communication unit 24a, and sends the working time information of the machine 21a to the maintenance-part replacement timing interval management system 100 of the machine manufacturing company via the network 14.

The maintenance-part replacement timing interval management system 100 forecasts the future demand for the maintenance part based on the maintenance-part supply history information and the machine working time information described above, on part-list information of the part-list memory unit 30, and on area-name list information of the area-name-list memory unit 31, and instructs the part manufacturing line 11 to produce a part without excess or deficiency.

<Configuration of Maintenance-Part Replacement Timing Interval Management System>

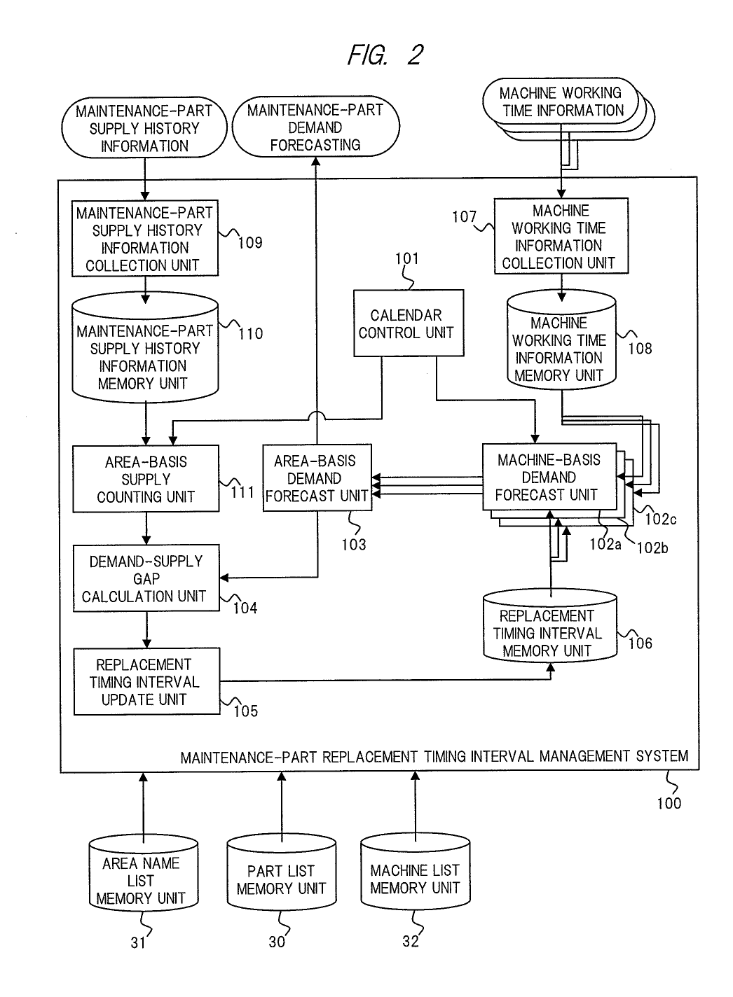

FIG. 2 is a configuration diagram showing an example of the maintenance-part replacement timing interval management system 100 shown in FIG. 1.

As shown in FIG. 2, the maintenance-part replacement timing interval management system 100 is configured of a calendar control unit 101, machine-basis demand forecast units 102a, 102b, and 102c (in some cases, simply described as 102), an area-basis demand forecast unit 103, a demand-supply gap calculation unit 104, a replacement timing interval update unit 105, a replacement timing interval memory unit 106, a machine working time information collection unit 107, a machine working time information memory unit 108, a maintenance-part supply history information collection unit 109, a maintenance-part supply history information memory unit 110, and an area-basis supply count unit 111. While details of each function or others will be described later in the description of overall operation, they mainly have the following functions.

The machine working time information collection unit 107 is a functional unit that collects the working time of each of the plurality of machines worked in the target areas where the machine operation conditions are similar to each other, and memorizes the working time in the machine working time information memory unit 108.

The maintenance-part supply history information collection unit 109 is a functional unit that collects the accumulated total number of actual maintenance-part supply of the maintenance part for the target area and memorizes the accumulated total number in the maintenance-part supply history information memory unit 110.

The machine-basis demand forecast units 102a, 102b, and 102c and the area-basis demand forecast unit 103 are the functional units that configure a demand forecast simulator unit, calculates past part replacement timing of each of the machines in the target area from a maintenance-part replacement timing interval for which a tentative value is previously determined and from the working time memorized in the machine working time information memory unit 108, and counts and outputs the accumulated total number of past maintenance-part replacement demand of all the machines in time series.

The demand-supply gap calculation unit 104 is a functional unit that calculates and outputs a maintenance-part demand-supply gap value which is the difference between the accumulated total number of maintenance-part replacement demands in time series output from the demand forecast simulator unit and the accumulated total number of maintenance-part supply memorized in the maintenance-part supply history information memory unit 110.

The replacement timing interval update unit 105 is a functional unit that calculates an optimum estimation value of the maintenance-part replacement timing interval which minimizes the maintenance-part demand-supply gap value output from the demand-supply gap calculation unit 104 while changing the tentative value of the maintenance-part replacement timing interval and outputs the optimum estimation value to the replacement timing interval memory unit 106.

In the configuration of the maintenance-part replacement timing interval management system 100 described above, the calendar control unit 101, the machine-basis demand forecast units 102a, 102b, and 102c, the area-basis demand forecast unit 103, the demand-supply gap calculation unit 104, the replacement timing interval update unit 105, the machine working time information collection unit 107, the maintenance-part supply history information collection unit 109, and the area-basis supply count unit 111 are the functional units which are achieved by a software.

The part list memory unit 30, the area-name list memory unit 31, and the machine list memory unit 32 in addition to the replacement timing interval memory unit 106, the machine working time information memory unit 108, and the maintenance-part supply history information memory unit 110 are allocated to memory devices including a database and others.

<Processing Procedure of Maintenance-Part Replacement Timing Interval Management System>

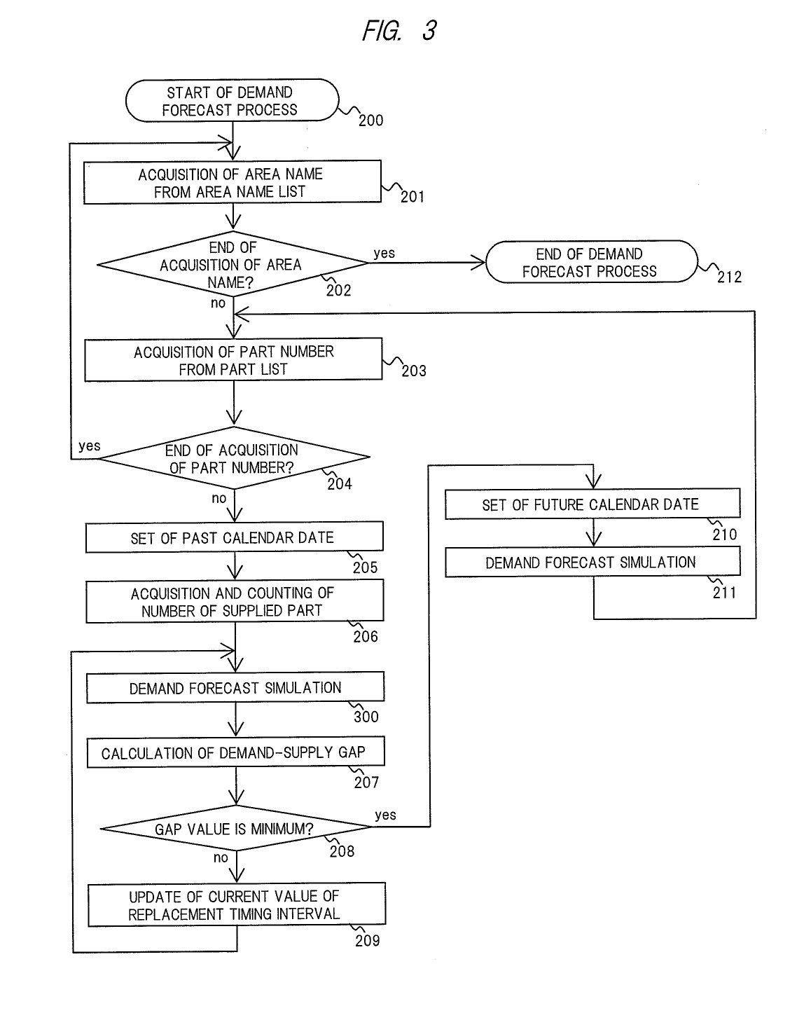

FIG. 3 is a flowchart showing an example of the processing procedure of the maintenance-part replacement timing interval management system 100 shown in FIG. 2.

As shown in FIG. 3, the processing procedure of the maintenance-part replacement timing interval management system 100 is configured of: start of a demand forecast process (step 200), acquisition of an area name from an area-name list (step 201), end of acquisition of the area name? (step 202), acquisition of a part number from a part list (step 203), end of acquisition of the part number? (step 204), setting of past calendar date (step 205), acquisition and count of the number of supplied parts (step 206), a demand forecast simulation (step 300), calculation of demand-supply gap (step 207), minimum gap value? (step 208), update of the current value of the replacement timing interval (step 209), setting of future calendar date (step 210), a demand forecast simulation (step 211), and end of the demand forecast process (step 212). Details of each of the operations and others will be described later in the description of the overall operation.

<Details of Demand Forecast Simulation>

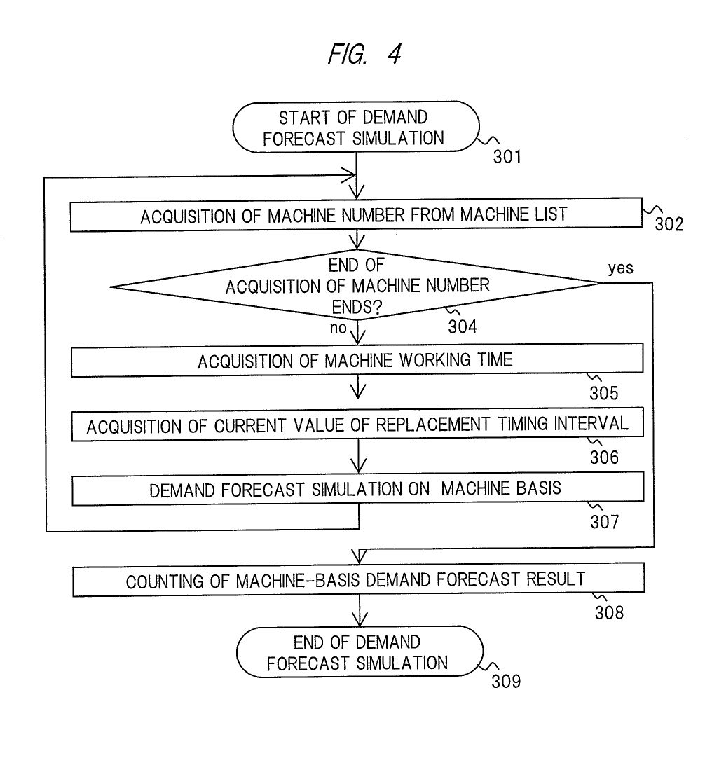

FIG. 4 is a detailed flowchart showing an example of the demand forecast simulation (step 300) in the processing procedure of the maintenance-part replacement timing interval management system 100 shown in FIG. 3.

As shown in FIG. 4, the details of the demand forecast simulation (step 300) is configured of: start of a demand forecast simulation (step 301), acquisition of a machine number from a machine list (step 302), end of acquisition of the machine number? (step 304), acquisition of machine working time (step 305), acquisition of the current value of the replacement timing interval (step 306), counting of machine-basis demand forecast results (step 308), and end of the demand forecast simulation (step 309). Details of each of operations and others will be described later in the description of the overall operation.

<Machine-Basis Replacement Event Simulation of Maintenance Part>

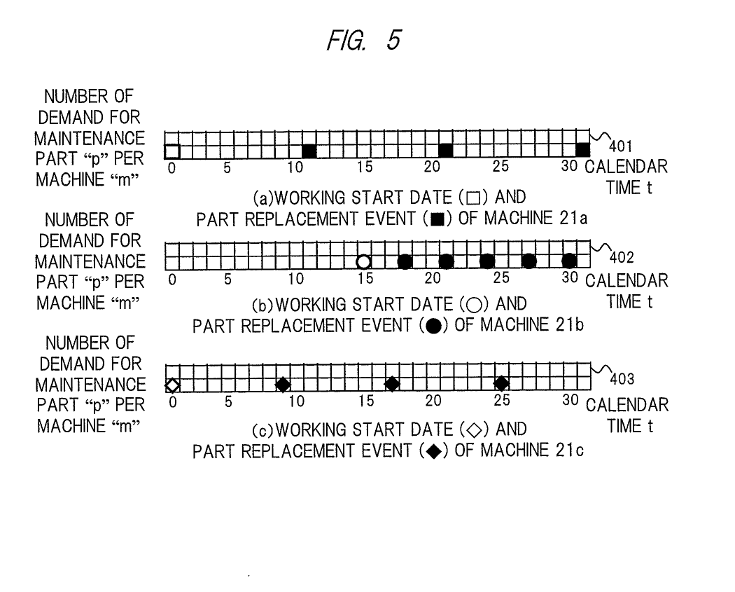

FIG. 5 to FIG. 9 are explanatory diagrams each showing an example of a machine-basis replacement event simulation of a maintenance part in the processing procedure of the maintenance-part replacement timing interval management system 100 shown in FIG. 3.

In FIG. 5, (a) shows a chart 401 of an operation start date and part replacement events of the machine 21a, (b) shows a chart 402 of an operation start date and part replacement events of the machine 21b, and (c) shows a chart 403 of an operation start date and part replacement events of the machine 21c. In FIG. 5 (a), (b), and (c), the horizontal axis shows calendar time “t”, and the vertical axis shows the number of demands for a maintenance part “p” of each machine “m”.

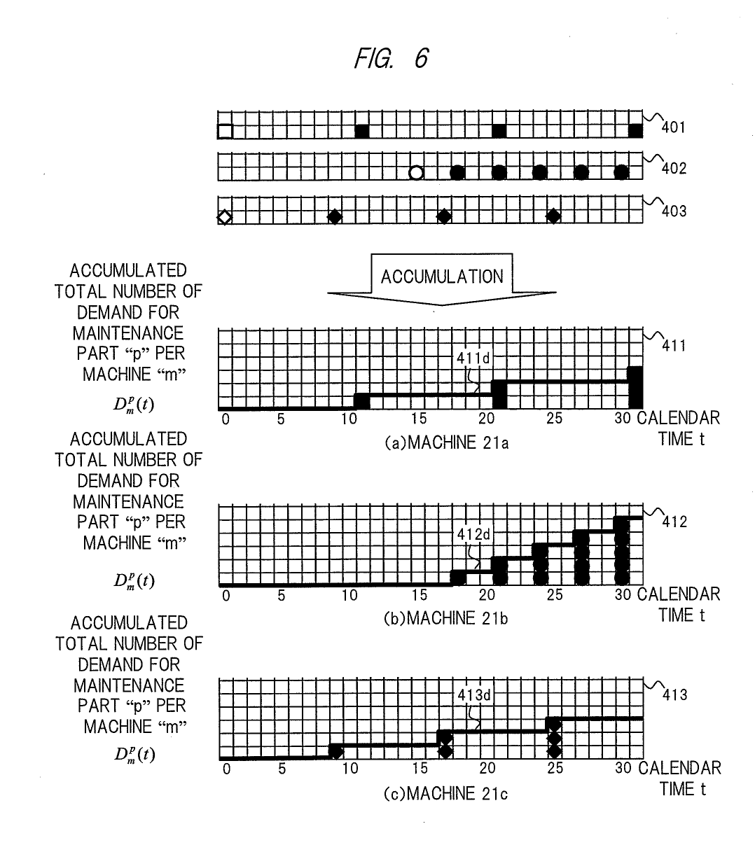

FIG. 6 shows the numbers of demands shown in FIG. 5 so as to be accumulated, (a) shows a chart 411 (rectangular line 411d) of the machine 21a, (b) shows a chart 412 (rectangular line 412d) of the machine 21b, and (c) shows a chart 413 (rectangular line 413d) of the machine 21c. In FIG. 6 (a), (b), and (c), the horizontal axis shows the calendar time “t”, and the vertical axis shows the accumulated total number of demands D^{p}ₘ (t) for the maintenance part “p” of each machine “m”.

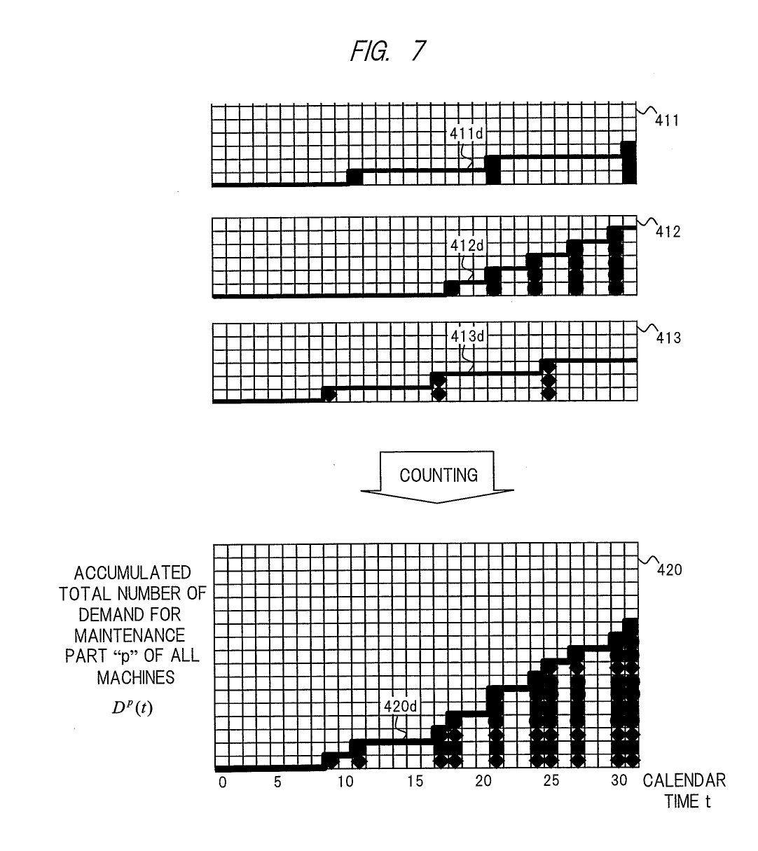

FIG. 7 shows a chart 420 (rectangular line 420d) in which the accumulated total number of demands shown in FIG. 6 is counted, and the horizontal axis shows the calendar time “t”, and the vertical axis shows an accumulated total number of demands “D^{p} (t)” of the maintenance part “p” of all the machines.

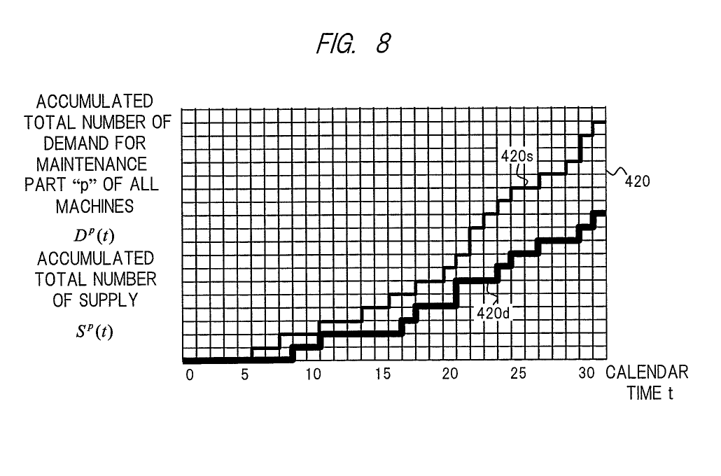

FIG. 8 shows a chart 420 showing the accumulated total number of demand D^{p} (t) of the maintenance part “p” of all the machines shown in FIG. 7 and the accumulated total number of supply S^{p} (t) thereof (a rectangular line 420d of the accumulated total number of demand D^{p} (t) and a rectangular line 420s of the accumulated total number of supply S^{p} (t)), and the horizontal axis shows the calendar time “t”, and the vertical axis shows the accumulated total number of demand D^{p} (t) and the accumulated total number of supply S^{p} (t) of the maintenance part “p” of all the machines.

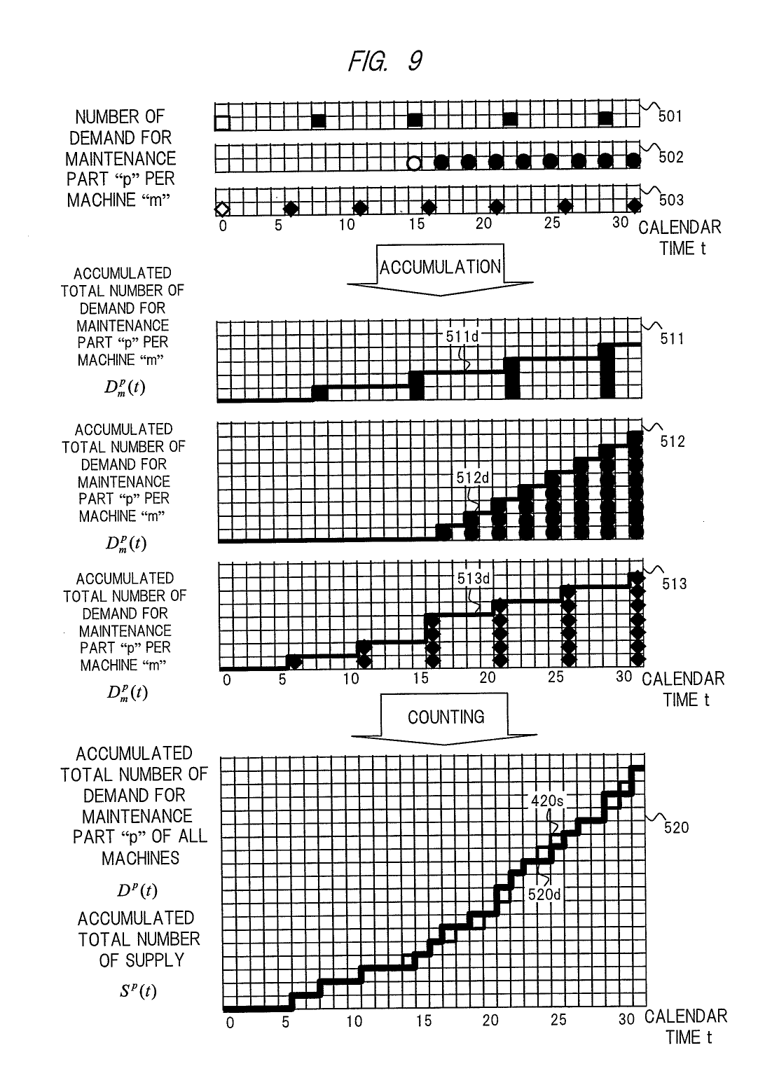

FIG. 9 shows charts 501, 502, and 503, charts 511 ((rectangular line 511d), 512 (rectangular line 512d), and 513 (rectangular line 513d), and a chart 520 (a rectangular line 520d of the accumulated total number of demand D^{p} (t) and a rectangular line 420s of the accumulated total number of supply S^{p} (t)) obtained when the replacement timing intervals of FIG. 5 to FIG. 8 are two-thirds of the initial values thereof.

Details of the machine-basis replacement event simulation of the maintenance part shown in FIG. 5 to FIG. 9 will be described later in the description of the overall operation.

<Configuration of Calculator System in Machine-Manufacturing-Company Operation Center>

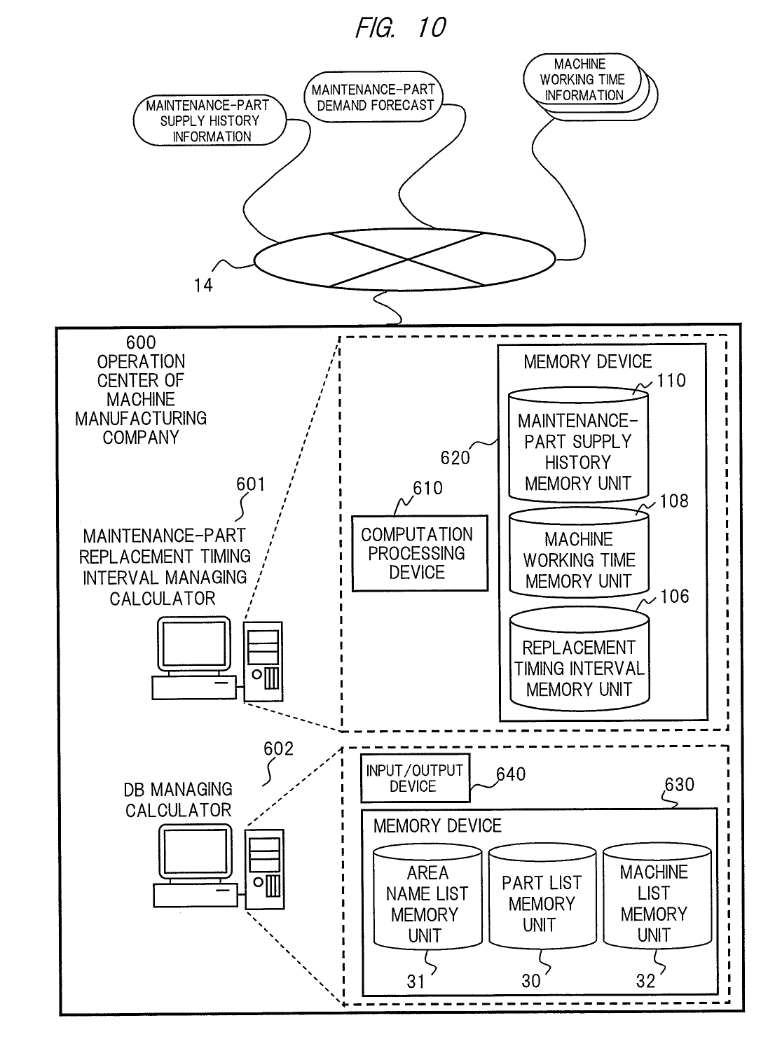

FIG. 10 is a configuration diagram showing an example of a calculator system in a machine-manufacturing-company operation center in the present embodiment.

As shown in FIG. 10, a machine-manufacturing-company operation center 600 is configured of a maintenance-part replacement timing managing calculator 601 and a database (DB) managing calculator 602. The maintenance-part replacement timing managing calculator 601 is provided with a computation processing device 610 and a memory device 620. The memory device 620 is provided with the maintenance-part supply history information memory unit 110, the machine working time information memory unit 108, and the replacement timing interval memory unit 106. The database managing calculator 602 is provided with an input/output device 640 and a memory device 630. The memory device 630 is provided with the area-name list memory unit 31, the part list memory unit 30, and the machine list memory unit 32.

All the processes described below are performed by the hardware of the maintenance-part replacement timing managing calculator 601 and the database managing calculator 602 shown in FIG. 10, and are achieved by the software that structures each functional unit of the maintenance-part replacement timing interval management system 100 shown in FIG. 2.

<Overall Operation of Maintenance-Part Supply Network including Maintenance-Part Replacement Timing Interval Management System>

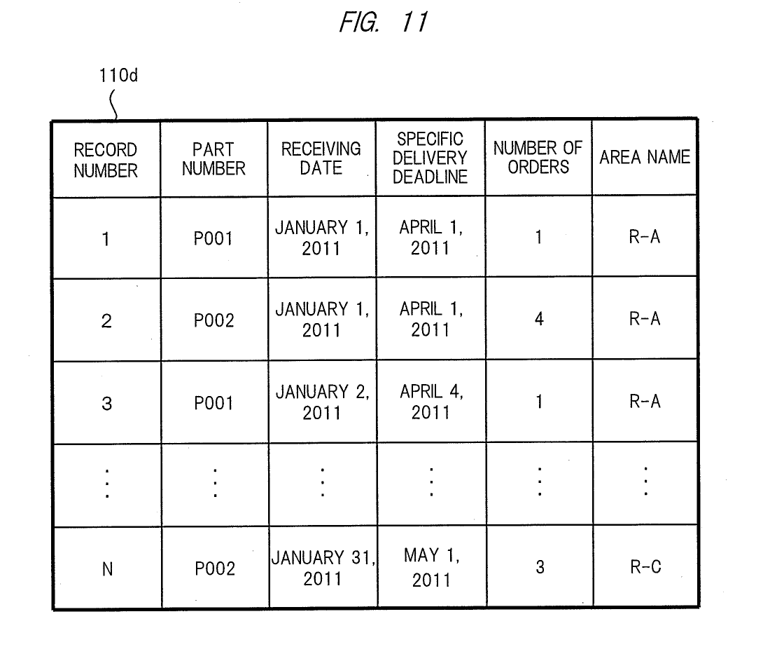

The overall operation of the maintenance-part supply network including the maintenance-part replacement timing interval management system of the present embodiment will be described by using FIG. 1 to FIG. 10 described above and further using FIG. 11 to FIG. 19.

(Collection and Memorizing of Information)

The machine working time information collection unit 107 collects the machine working time information described in FIG. 1 in such a predetermined cycle as a monthly basis, a daily basis, or others, and memorizes the information in the machine working time information memory unit 108. The maintenance-part supply history information collection unit 109 collects the maintenance-part supply history information described in FIG. 1 in such a predetermined cycle as a monthly basis, a daily basis, or others, and memorizes the information in the maintenance-part supply history information memory unit 110.

Hereinafter, the processing procedure of the maintenance-part replacement timing interval management system 100 will be described based on FIG. 2 and with reference to other drawings.

(Start of Demand Forecast Process)

The maintenance-part replacement timing interval management system 100 starts the demand forecast process in a predetermined cycle or by a process-starting trigger signal from outside, and executes the process in accordance with the processing procedure of FIG. 3 (step 200 of FIG. 3).

(Repetitive Control)

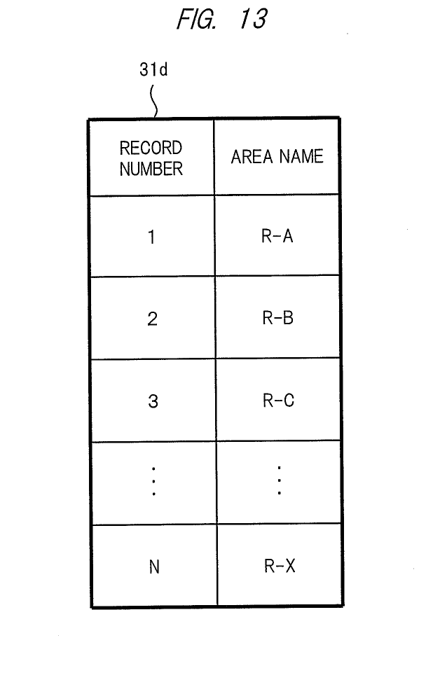

The maintenance-part replacement timing interval management system 100 acquires area names in the order of a list from the area-name list memory unit 31 (step 201 of FIG. 3). An example of the area-name list is shown in FIG. 13. The record configuration of an area-name list 31d includes at least an “area name” column (for example, R-A, R-B, R-C, . . . R-X). In the example of FIG. 13, the area names are acquired sequentially from “R-A” as the “area name”.

The following procedure is repeated until the acquisition of the area names ends (in a case of “no” in step 202 of FIG. 3). When the acquisition of the area names ends, the demand forecast process ends (step 212 of FIG. 3) (in a case of “yes” in step 202 of FIG. 3).

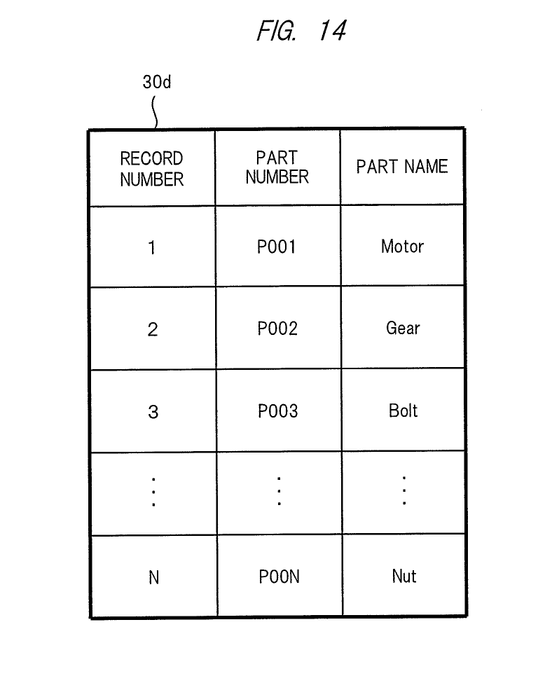

The maintenance-part replacement timing interval management system 100 acquires part numbers in the order of a list from the part list memory unit 30 (step 203 of FIG. 3), and repeats the following procedure (in a case of “no” in step 204 of FIG. 3) until the acquisition of the part numbers ends. An example of the part list is shown in FIG. 14. The record configuration of a part list 30d includes at least a “part number” column (for example, P001, P002, P003, . . . P00N). The column of “part name” (for example, Motor, Gear, Bolt, . . . Nut) is required when display by a screen interface is performed. In the example of FIG. 14, the part numbers are acquired sequentially from “Motor” of “P001” as the “part number”.

When the acquisition of the part numbers ends, the process returns to the acquisition of the area names (step 201 of FIG. 3) (in a case of “yes” in step 204 of FIG. 3).

(Calendar Control)

The calendar control unit 101 sets the year/month/day data of a past predetermined period for the machine-basis demand forecast units 102a, 102b, and 102c and the area-basis supply count unit 111 (step 205 of FIG. 3).

(Count of Area-Basis Supply)

Based on the area name, the area-basis supply count unit ill acquires, the number of maintenance-part supply of the corresponding part which has been supplied to the corresponding area for the set year/month/day period from the maintenance-part supply history information collection unit 109, and counts the accumulated total number of supply thereof in the order of time series (step 206 of FIG. 3).

An example of the maintenance-part supply history information is shown in FIG. 11. The record configuration of maintenance-part supply history information 110d includes at least of “part number” column (for example, P001, P002, P001, . . . , P002), “order date” column (for example, Jan. 1, 2011, Jan. 1, 2011, Jan. 2, 2011, . . . , Jan. 31, 2011), or “specific delivery deadline” column (for example, Apr. 1, 2011, Apr. 1, 2011, Apr. 4, 2011, . . . , May 1, 2011), “the number of orders” column (for example, 1, 4, 1, . . . , 3), and “area name” column (for example, R-A, R-A, R-A, . . . , R-C).

(Start of Demand Forecast Simulation)

The maintenance-part replacement timing interval management system 100 starts a demand forecast simulation (step 300 of FIG. 3) in the following detailed procedure (step 301 of FIG. 4).

(Acquisition of Machine Number)

The machine-basis demand forecast unit 102a acquires the machine number of the machine (for example, 21a) of the machine operating company (for example, 20a of FIG. 1) worked in the corresponding area based on the area name from the machine list memory unit 32 (step 302 of FIG. 4).

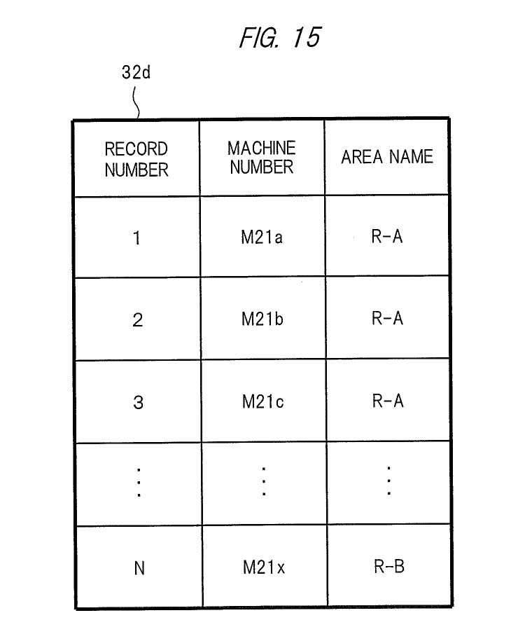

An example of a machine list is shown in FIG. 15. The record configuration of a machine list 32d includes at least a “machine number” column (for example, M21a, M21b, M21c, . . . , M21x) and an “area name” column (for example, R-A, R-A, R-A, . . . , R-B).

The following procedure is repeated until acquisition of the machine working time ends (in a case of “no” in step 304 of FIG. 4).

(Acquisition of Machine Working Time)

Based on the machine number, the machine-basis demand forecast unit 102a acquires the time-series working time of the machine for the year/month/day period set from the machine working time information memory unit 108 (step 305 of FIG. 4).

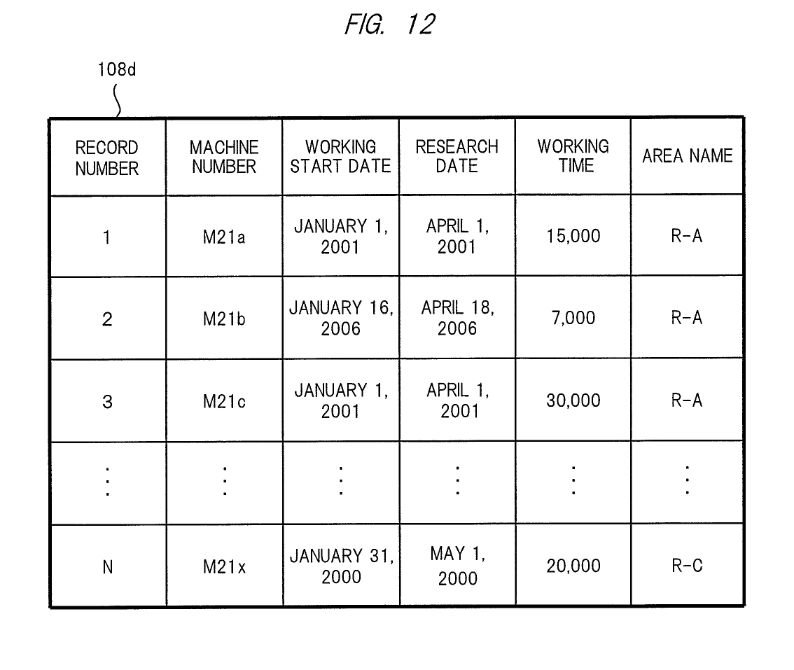

An example of the machine working time information is shown in FIG. 12. The record configuration of machine working time information 108d includes at least columns of a “machine number” column (for example, M21a, M21b, M21c, . . . , M21x), a “movement start date” column (for example, Jan. 1, 2001, Jan. 16, 2006, Jan. 1, 2001, Jan. 31, 2000), or a “research date” column (for example, Apr. 1, 2001, Apr. 18, 2006, Apr. 1, 2001, . . . , May 1, 2000), a “working time” column (for example, 15000, 7000, 30000, . . . , 20000), and an “area name” column (for example, R-A, R-A, R-A, . . . , R-C).

(Acquisition of Current Replacement Timing Interval Value)

The machine-basis demand forecast unit (for example, 102a, 102b, 102c) acquires the current replacement timing interval value of the corresponding part in the corresponding area from the replacement timing interval memory unit 106 of the maintenance part (step 306 of FIG. 4). As an initial value of the current replacement timing interval value, for example, a designed life for a standard specification environment may be set.

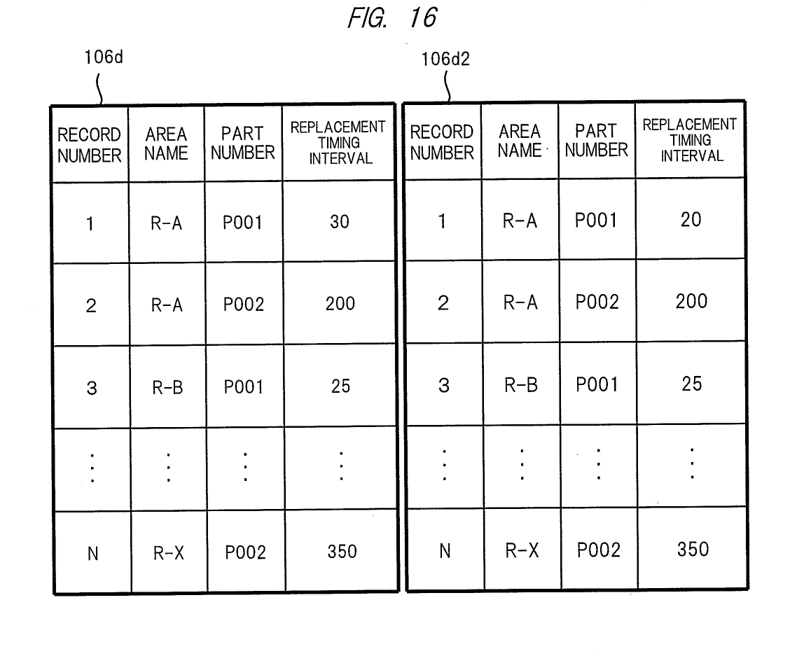

An example of a replacement timing interval list memorized in the replacement timing interval memory unit 106 of the maintenance part is shown in FIG. 16. The record configuration of a replacement timing interval list 106d includes at least an “area name” column (for example, R-A, R-A, R-B, . . . , R-X), a “part number” column (for example, P001, P002, P001, . . . , P002), and a “replacement timing interval” column (for example, 30, 200, 25, . . . , 350). For example, “30” is acquired as the current replacement timing interval value of the part number “P001” in the area name “R-A”.

(Machine-Basis Demand Forecast Simulation)

The machine-basis demand forecast unit (for example, 102a, 102b, 102c) performs the demand forecast simulation of the maintenance part on machine basis, and generates time-series demand forecast data (step 307 of FIG. 4). Specifically, based on the equation of Formula 1, the accumulated total number of demand of the maintenance part “p” of the machine “m” on the date “t” is generated.

$${D}_{m}^{p} ( t ) = [ \frac{{W}_{m} ( t )}{{Interval}_{p}} ] \times {q}_{m}^{p}$$

Dₘ^{p}(t): The accumulated total number of the maintenance part “p” of the machine “m” on the date “t”
Wₘ(t): The accumulated total working time
   Intervalₚ: The replacement timing interval of the maintenance part “p”
wₘ^{p}. The number of members using the maintenance part “p” in the machine “m”
[x]: Truncating integer of real number “x”

When the above-described process ends, the machine-basis demand forecast unit 102a returns to acquisition of machine working time (step 302 of FIG. 4). When the acquisition of the machine working time ends (in a case of “yes” in step 304 of FIG. 4), the process proceeds as follows.

FIG. 5 shows the charts 401, 402, and 403 as examples of simulations of occurrence of machine-basis maintenance-part replacement events for the three machines. The horizontal axis shows the calendar time (year/month/day) “t”, and the vertical axis shows the number of demands for the maintenance part “p” of each machine “m”. The operation start dates of the machine 21a (a) and the machine 21c (c) are “t=0”, while the operation start date of the machine 21b (b) is “t=15” which is later than the date. The three machines are used in similar environments, and the replacement timing interval of the part p is the same. However, the working time per day is different. The working time per day of the machine 21a is the shortest, and the replacement event interval thereof is “t=10”. The working time per day of the machine 21b is the longest, and the replacement event interval thereof is “t=3”. The working time per day of the machine 21c is between them in the working time, and the replacement event interval thereof is “t=8”. While the number of parts required for each replacement event is set to one, an arbitrary number is no problem.

FIG. 6 shows the charts 411, 412, and 413 as examples of the simulations of the accumulated total number of machine-basis maintenance-part demand for the three machines. The rectangular lines 411d, 412d, and 413d of the accumulated total number of demand can be obtained by accumulating the numbers of the parts for each time-series replacement event of FIG. 5.

(Area-Basis Demand Forecast)

The area-basis demand forecast unit 103 generates the accumulated total number of demand of the maintenance part “p” of all the machines “m” in the corresponding area by counting the accumulated total number based on the equation of Formula 2 (step 308 of FIG. 4).

$${D}^{p} ( t ) = {\sum }_{m ∈ ( 21 a , 21 b , 21 c )} {D}_{m}^{p} ( t ) \qquad [ Formula 2 ]$$

D^{p}(t): The accumulated total number of the maintenance part “p” of all machines on the date “t”

FIG. 7 shows the chart 420 in which the accumulated total number of demand of the maintenance parts is counted. The rectangular line 420d of the accumulated total number of demand of the maintenance part “p” of all the machines is obtained by counting the rectangular lines 411d, 412d, and 413d of the accumulated total number of demand of the maintenance part “p” on machine basis for the three machines of FIG. 6 worked under the same use conditions.

The maintenance-part replacement timing interval management system 100 ends (step 309 of FIG. 4) the demand forecast simulation (step 300 of FIG. 3).

(Demand-Supply Gap Calculation)

Based on the equation of Formula 3, the demand-supply gap calculation unit 104 calculates the difference between the accumulated total number of the time-series maintenance-part supply from the area-basis supply count unit 111 and the accumulated total number of the time-series maintenance-part demand from the area-basis demand forecast unit 103 as an accumulated total number of demand-supply gap (step 207 of FIG. 3).

ΔD^{p}(t)=S^{p}(t)−_{D}^{p}(t) [Formula 3]

ΔDₚ(t): The accumulated total number of demand-supply gap of the maintenance part “p” on the date “t”

S^{p}(t): The accumulated total number of supply of the maintenance part “p” on the date “t”

Furthermore, based on the equation of Formula 4, the demand-supply gap calculation unit 104 counts the accumulated total number of demand-supply gap in a time-axis direction, and calculates a demand-supply gap value. It is determined whether the demand-supply gap value has converged on a minimum value or not, and, if it is not determined that the value has converged, the process proceeds to the following update process for the replacement timing interval (in a case of “no” in step 208 of FIG. 3). If it is determined that the value has converged, the process proceeds to a process of a later-described future demand forecast (in a case of “yes” in step 208 of FIG. 3).

$$Δ {D}_{sum}^{p} = {\sum }_{t} Δ {D}^{p} ( t ) \qquad [ Formula 4 ]$$

ΔDₛᵤₘ^{p}: The time counted value of the accumulated total number of the demand-supply gap of the maintenance part “p”

FIG. 8 shows the chart 420 in which the rectangular line 420s of the accumulated total number of supply of the maintenance part “p” to the corresponding area is added to the rectangular line 420d of the accumulated total number of demand of the maintenance part “p” of all the machines in the corresponding area of FIG. 7. The difference between the rectangular line 420s of the accumulated total number of supply and the rectangular line 420d of the accumulated total number of demand becomes a rectangular line (not shown) of the accumulated total number of demand-supply gap. The demand-supply gap value is obtained from an area size of the rectangular line (not shown) of the accumulated total number of demand-supply gap. Obviously even without showing, the demand-supply gap value of FIG. 8 becomes a positive value.

(Update for Replacement Timing Interval)

The replacement timing interval update unit 105 updates the current value of the replacement timing interval so that the demand-supply gap value from the demand-supply gap calculation unit 104 becomes small (step 209 of FIG. 3), and memorizes the value in the replacement timing interval memory unit 106.

For example, if the demand-supply gap value is positive, the number of the actual maintenance-part supply is larger than a simulation estimation value of the number of demand, and therefore, the current value of the replacement timing interval is decreased in order to increase the simulation estimation value of the number of demand. Conversely, if the demand-supply gap value is negative, the number of the actual maintenance-part supply is smaller than the simulation estimation value of the number of demand, and therefore, the current value of the replacement timing interval is increased in order to decrease the simulation estimation value of the number of demand.

If an update range is sufficiently small, the demand-supply gap value converges on a minimum value through the repetition from the simulation of the number of demand (step 300 of FIG. 3) to the update of the current value of the replacement timing interval (step 209 of FIG. 3). In order to shorten the calculation time, the update range can be changed from a large range to a small range at any time.

Since the demand-supply gap value of FIG. 8 is a positive value, the current value of the replacement timing interval is reduced. FIG. 9 shows the charts obtained when the replacement timing interval has become a value “20” that is two thirds of the initial value “30” by repeating this reduction.

In the charts 501, 502, and 503 of FIG. 9 of the occurrence simulations of the replacement events of the maintenance parts, the intervals of the occurrence of the replacement events are shortened to two thirds of those of FIG. 5 as a result of shortening of the replacement timing interval.

As a result, in the charts 511, 512, and 513 of FIG. 9 of the simulation result of the accumulated total number of demand of the maintenance parts on machine basis, the accumulation speeds of the rectangular lines 511d, 512d, and 513d of the accumulated total number of demand are higher than that of FIG. 6.

The rectangular line 520d of the chart 520 obtained by counting the rectangular lines 511d, 512d, and 513d of their accumulated total number of demand on machine basis becomes closer to the rectangular line 420s of the accumulated total number of supply, so that the demand-supply gap positive and negative values are cancelled by each other to become zero or a minimum value. In this manner, by shortening the replacement timing interval, a sign of the demand-supply gap value is inverted to become a negative value. Therefore, the replacement timing interval estimation value at this time becomes an optimum estimation value of the maintenance-part replacement timing interval of the machine operating company.

An example of the replacement timing interval list updated by the replacement timing interval update unit 105 is shown in a replacement timing interval list 106d2 of FIG. 16. In this example, the current value “30” of the replacement timing interval of the part number “P001” in the area name “R-A” is updated to “20”.

(Future Demand Forecast) If the demand-supply gap calculation unit 104 determines that the above-described demand-supply gap value has converged on the minimum value, the calendar control unit 101 sets a predetermined future calendar in the machine-basis demand forecast unit (for example, 102a, 102b, 102c) (step 210 of FIG. 3).

The maintenance-part replacement timing interval management system 100 performs the demand forecast simulation (step 211 of FIG. 3) by using a latest current value of the replacement timing interval for the future calendar in the procedure of FIG. 4 described above.

Then, the maintenance-part replacement timing interval management system 100 returns to acquisition of the part number (step 203 of FIG. 3).

Then, after the demand forecast process ends (step 212 of FIG. 3), the maintenance-part replacement timing interval management system 100 sends the result of the maintenance-part demand forecast to the part manufacturing line of the machine manufacturing company (11 of FIG. 1).

(Screen Interface)

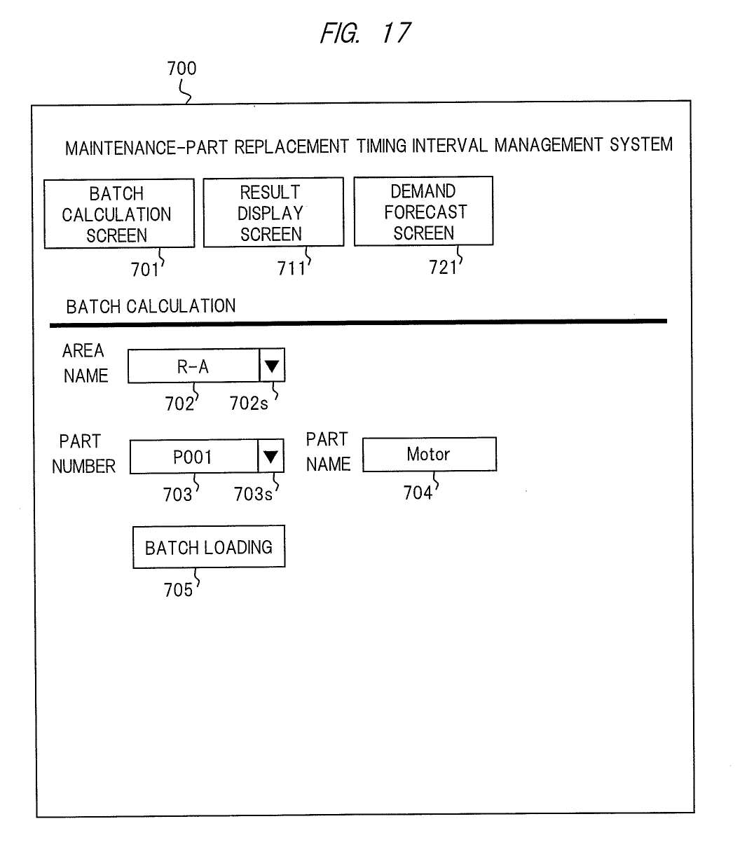

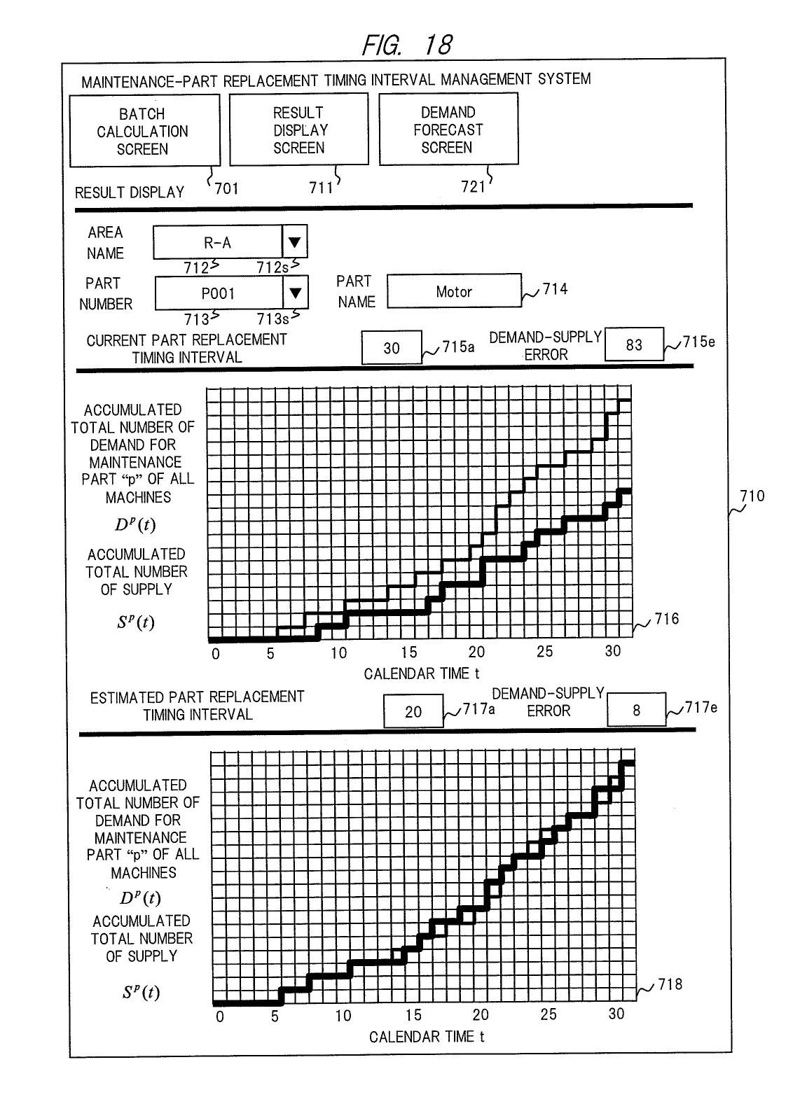

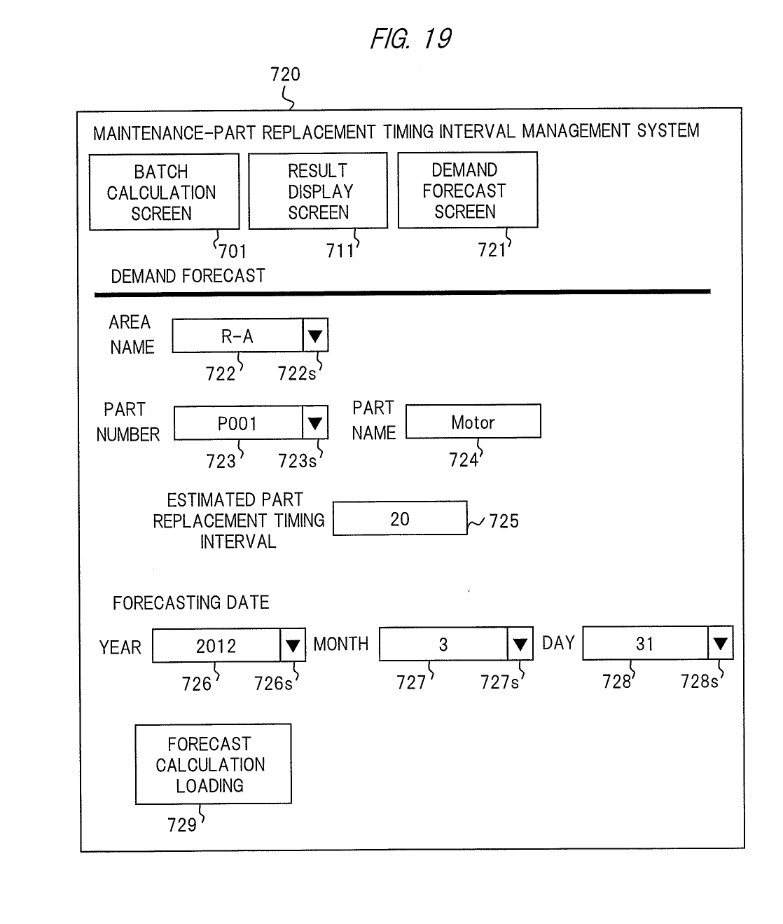

FIG. 17 to FIG. 19 show screen interfaces of the maintenance-part replacement timing interval management system 100. FIG. 17 shows an example of a batch calculation screen, FIG. 18 shows an example of a result display screen, and FIG. 19 shows an example of a demand forecast screen.

(Screen interface: Batch Calculation Screen)

The processes from the estimation of the maintenance-part replacement timing interval to the demand forecast described above can be automatically performed for all the areas and all the parts by the maintenance-part replacement timing managing calculator 601 and the database (DB) managing calculator 602 shown in FIG. 10. However, a batch calculation screen 700 of FIG. 17 controlled by the maintenance-part replacement timing managing calculator 601 can be also enables selectively processed.

The batch calculation screen 700 includes a batch-calculation-screen switch button 701, a result-display-screen switch button 711 in an upper part, so that the screens of FIG. 17, FIG. 18, and FIG. 19 can be switched.

The batch calculation screen 700 includes an area-name selection text entry 702, so that the target area for which the processes from estimation of the maintenance-part replacement timing interval to the demand forecast are performed can be selected. The content of the area name list 31d of FIG. 13 is displayed by using a pull-down button 702s, so that the area name can be selected. A selection item “all” (ALL) is included in the area-name pull-down list, and, if this item is selected, the process can be performed for all the areas.

The batch calculation screen 700 includes a part-number selection text entry 703, so that a target part for which the processes from the estimation of the maintenance-part replacement timing interval to the demand forecast are performed can be selected. The content of the part list 30d of FIG. 14 is displayed by using a pull-down button 703s, so that the part number can be selected. The part name corresponding to the selected part number is displayed in a part-name text box 704. A selection item “all” (ALL) is included in the part-name pull-down list, and, if this item is selected, the process can be performed for all the parts.

The batch calculation screen 700 includes a batch input button 705. When this button is clicked, the automatic processes from the estimation of the maintenance-part replacement timing interval to the demand forecast are performed for the selected part (including all the selected part(s)) in the selected area name (including all the selected area name(s)) by the maintenance-part replacement timing interval managing calculator 601 and the database (DB) managing calculator 602 shown in FIG. 10.

(Screen Interface: Result Display Screen)

On a result display screen 710 of FIG. 18 controlled by the maintenance-part replacement timing interval managing calculator 601, the part replacement timing interval which is obtained by executing the batch calculation screen 700 can be selectively displayed.

The result display screen 710 includes the batch-calculation-screen switch button 701, the result-display-screen switch button 711, and the demand-forecast-screen switch button 721 in an upper part, so that the screens of FIG. 17, FIG. 18, and FIG. 19 can be switched.

The result display screen 710 includes an area-name selection text entry 712, so that a target area displaying the result of the maintenance-part replacement timing interval can be selected. The content of the area name list 31d of FIG. 13 is displayed by using pull-down button 712s, so that the area name can be selected.

The result display screen 710 includes a part-number selection text entry 713, so that a target part displaying the result of the maintenance-part replacement timing interval can be selected. The content of the part list 30d of FIG. 14 is displayed by using a pull-down button 713s, so that the part number can be selected. The part name corresponding to the selected part number is displayed in a part-name text box 714.

The result display screen 710 includes a current part replacement timing interval text box 715a and a part replacement timing interval text box 717a that is estimated at this time, and the maintenance-part replacement timing managing calculator 601 displays a value. Moreover, the screen includes a demand-supply error text box 715e based on the current part replacement timing interval and a demand-supply error text box 717e based on the part replacement timing interval estimated at this time, and the maintenance-part replacement timing managing calculator 601 displays a value. Moreover, the maintenance-part replacement timing managing calculator 601 displays the values of a chart 716 of the accumulated total number of demand and the accumulated total number of supply based on the current part replacement timing interval and a chart 718 of the accumulated total number of demand and the accumulated total number of supply based on the part replacement timing interval estimated at this time.

(Screen Interface: Demand Forecast Screen)

A demand forecast screen 720 of FIG. 19 controlled by the maintenance-part replacement timing managing calculator 601 can executes the demand forecast of a specific period by using the part replacement timing interval obtained by the execution of the batch calculation screen 700.

The demand forecast screen 720 includes the batch-calculation-screen switch button 701, the result-display-screen switch button 711, and the demand forecast screen switch button 721 in an upper part, so that the screens of FIG. 17, FIG. 18, and FIG. 19 can be switched.

The demand forecast screen 720 includes an area-name selection text entry 722, so that the target area for which the demand forecast is performed can be selected. The content of the area name list 31d of FIG. 13 is displayed by using pull-down button 722s, so that the area name can be selected. A selection item “all” (ALL) is included in the area-name pull-down list, and, if this item is selected, the process can be performed for all the areas.

The demand forecast screen 720 includes a part-number selection text entry 723, so that the target part for which the demand forecast is performed can be selected. The content of the part list 30d of FIG. 14 is displayed by using a pull-down button 723s, so that the part number can be selected. The part name corresponding to the selected part number is displayed in a part-name text box 724. A selection item “all” (ALL) is included in the part pull-down list, and, if this item is selected, the process can be performed for all the parts.

The demand forecast screen 720 includes a part replacement timing interval text box 725 estimated at this time and used for the demand forecast, and the maintenance-part replacement timing managing calculator 601 displays a value.

The demand forecast screen 720 includes forecast date text entries 726, 727, and 728, so that the end date of the demand forecast executed by the maintenance-part replacement timing managing calculator 601 is specified. They include pull-down buttons 726s, 727s, and 728s, respectively, and can be specified from a calendar.

The demand forecast screen 720 includes a forecast-calculation input button 729. By clicking this button, the automatic process of the demand forecast based on the estimated maintenance-part replacement timing interval of the selected part(s) (including selection of all parts) in the selected area name(s) (including selection of all area names) is executed by the maintenance-part replacement timing managing calculator 601 and the database (DB) managing calculator 602 shown in FIG. 10.

### Effect of First Embodiment

As described above, according to the method and the system of managing the maintenance-part replacement timing interval of the present first embodiment, the machine working time information collection unit 107, the maintenance-part supply history information collection unit 109, the machine-basis demand forecast unit 102, the area-basis demand forecast unit 103, the demand-supply gap calculation unit 104, the replacement timing interval update unit 105, etc. are provided, so that a demand forecast simulation is performed by collecting the working time of each of the plurality of machines worked in the target areas where the machine operation conditions are similar to each other, by collecting the accumulated total number of the actual maintenance-part supply of the maintenance part for the target area, by calculating the past part replacement timing of each of the machines in the target area from the working time and the maintenance-part replacement timing interval for which a tentative value is previously determined, and by counting the accumulated total number of the past maintenance-part replacement demand of all the machines in a time series, the maintenance-part demand-supply gap value which is the difference between the accumulated total number of maintenance-part replacement demand and the accumulated total number of maintenance-part supply in time series is calculated, the optimum estimation value of the maintenance-part replacement timing interval which minimizes the maintenance-part demand-supply gap value is calculated while changing the tentative value of the maintenance-part replacement timing interval, and the future demand for the maintenance part is forecasted by using the optimum estimation value of the maintenance-part replacement timing interval, and therefore, the following effect can be obtained.

That is, as the effects of the method and the system of managing the maintenance-part replacement timing interval of the present first embodiment, the replacement timing interval of the maintenance part replaced by the machine operating company in accordance with the use environment of each machine of the company itself can be estimated on the machine manufacturing company side, and the demand for the maintenance part can be forecasted based on the estimation value at a high accuracy without excess or deficiency. In this manner, for the machine manufacturing company, it is only required to prepare a necessary amount of the maintenance parts as many as only required at required time, and therefore, stock management cost can be reduced.

### Second Embodiment

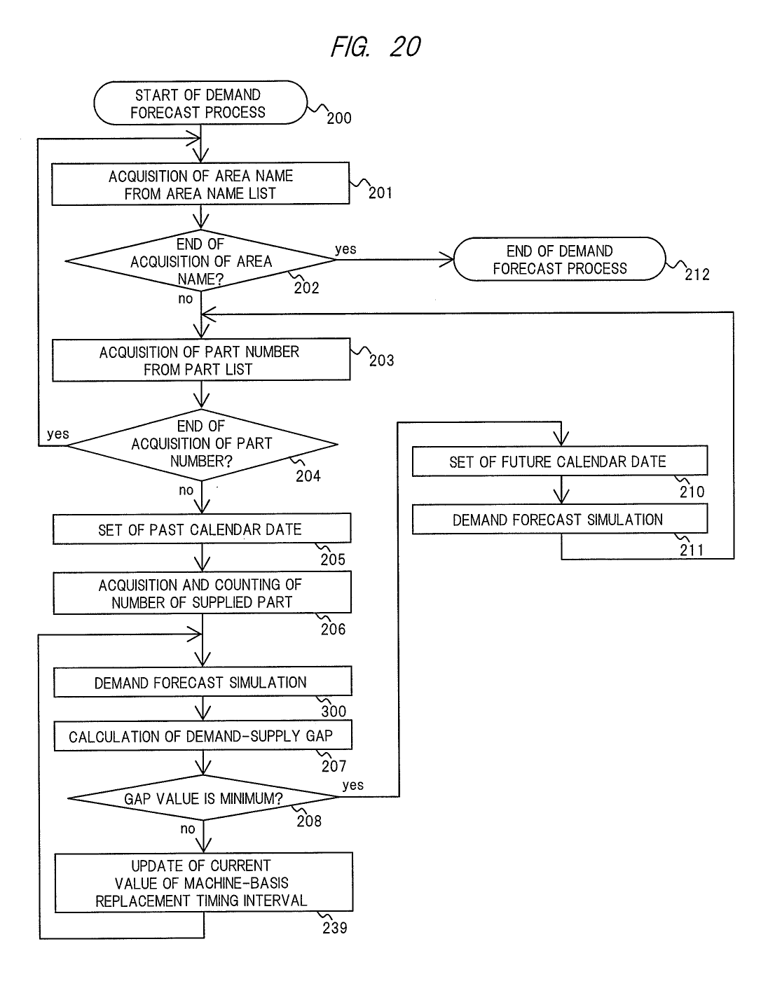

A method and a system of managing the replacement timing interval of a maintenance part of a second embodiment will be described by using FIG. 20 to FIG. 22.

In the present embodiment, an example of a method and a system of managing a maintenance-part replacement timing interval will be described, the method and the system not estimating only one replacement timing interval of the maintenance part of all the machines worked in all the specific areas but capable of individually forecasting the replacement timing interval of the maintenance part of each machine.

<Overall Operation of Maintenance-Part Supply Network Including Maintenance-Part Replacement Timing Interval Management System>

FIG. 20 is a flowchart showing an example of a processing procedure of the maintenance-part replacement timing interval management system 100 of the present embodiment. In FIG. 20, the update of the current value of the replacement timing interval (step 209) is changed to update of the current value of the replacement timing interval of each machine (step 239) compared with FIG. 3.

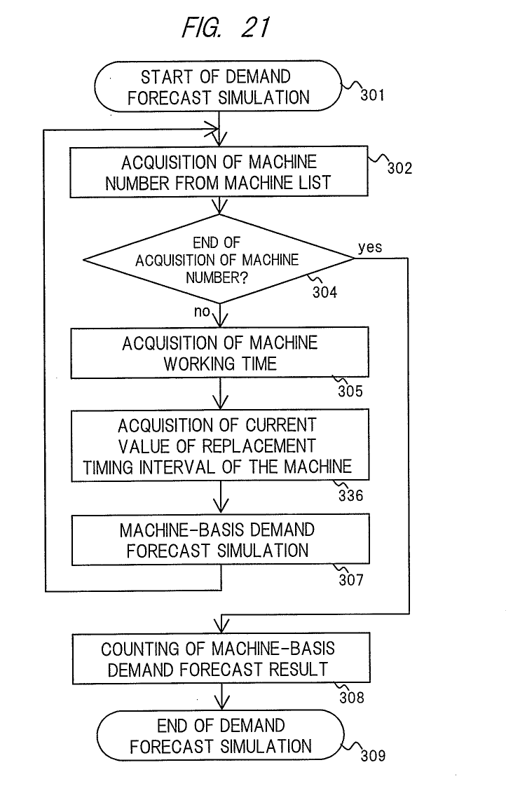

FIG. 21 is a detailed flowchart showing an example of a demand forecast simulation (step 300) of the processing procedure of the maintenance-part replacement timing interval management system 100 shown in FIG. 20. In FIG. 21, the acquisition of the current value of the replacement timing interval (step 306) is changed to acquisition of the current value of the replacement timing interval of the machine (step 336) in comparison with FIG. 4.

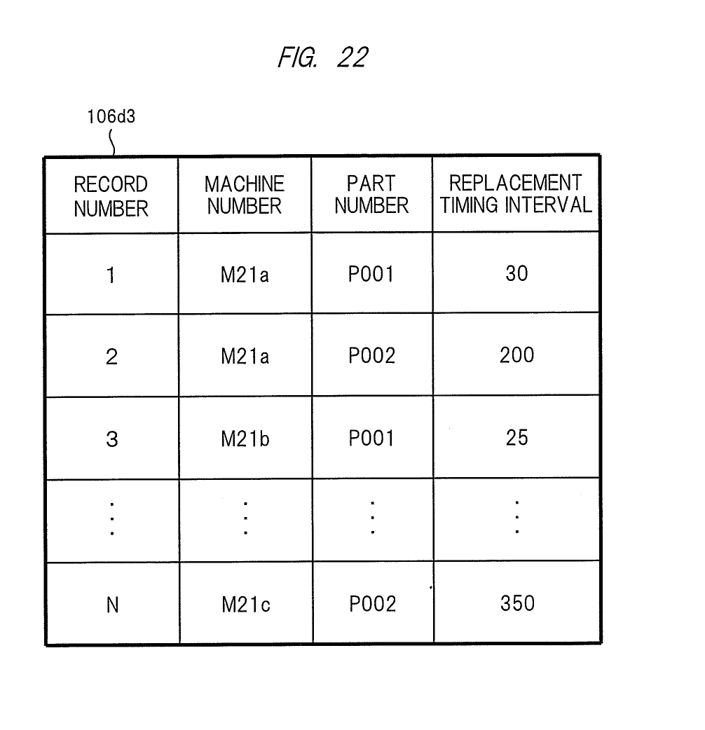

FIG. 22 is an explanatory diagram showing an example of the replacement timing interval list memorized in the replacement timing interval memory unit 106 of the maintenance part in the maintenance-part replacement timing interval management system 100 of the present embodiment. In a replacement timing interval list 106d3 of FIG. 22, “area name” is changed to “machine number” (for example, M21a, M21a, M21b, . . . , M21c) in comparison with FIG. 16.

Descriptions will be omitted for the portion having the same functions as the configurations denoted with the same reference symbols shown in the drawings already described in the above-described first embodiment.

In the demand forecast simulation of FIG. 21, the maintenance-part replacement timing interval management system 100 does not acquire the current value of the part replacement timing interval which is common among all the machines in the corresponding area but acquires the current value of the part replacement timing interval which is unique to the corresponding machine in the corresponding area (step 336 of FIG. 21). Specifically, for example, the current value “30” of the part replacement timing interval of the part number “P001” of the machine number “M21a” is acquired from the replacement timing interval list 106d3 of FIG. 22. That is, a machine-basis demand forecast simulation (step 307 of FIG. 21) is executed by using the part replacement timing interval, which is different for each machine. Subsequently, the demand forecasts of all the machines in the corresponding area (step 308 of FIG. 21) are counted.

Since the supplied amount of the maintenance part for each individual machine cannot be figured out in the machine manufacturing company, the gap between the supplied amount of the maintenance part for the corresponding area and the counted value of the demand forecast of all the machines in the corresponding area is calculated (step 207 of FIG. 20).

The magnitude of the gap value thereof is judged (step 208 of FIG. 20), and, if the gap value has not converged on a minimum value, update of the current value of the replacement timing interval for each machine (step 239 of FIG. 20) is executed. The replacement timing interval may be updated for each machine through the loop from the demand forecast simulation (step 300 of FIG. 20) to the update of the current value of the replacement timing interval for each machine (step 239 of FIG. 20), or the replacement timing interval of all the machines may be updated.

As an updating method, all-area search in a parameter space of the replacement timing interval, heuristic search (hill climbing method, genetic algorithm, simulated annealing method, taboo search, particle swarm optimization, etc.), or MCMC (Markov Chain Monte Carlo) method is selectively used depending on the number of parameters and allowable search time.

### Effect of Second Embodiment

As described above, according to the method and the system of managing the maintenance-part replacement timing interval of the present second embodiment, as a process different from that of the above-described first embodiment, the maintenance-part replacement timing interval is set as the individual value for each machine, the past part replacement timing of each machine is calculated by using the part replacement timing interval of each machine, the accumulated total number of the past maintenance-part replacement demand of all the machines in the target area is counted in time series, the maintenance-part demand-supply gap value which is the difference between the accumulated total number of maintenance-part replacement demand in the target area and the accumulated total number of maintenance-part supply supplied to the target area is calculated, and the optimum estimation value of the maintenance-part replacement timing interval for each machine which minimizes this maintenance-part demand-supply gap value is calculated, and the future demand for the maintenance part is forecasted by using the optimum estimation value of the maintenance-part replacement timing interval, so that the following effect can be obtained.

That is, as the effect of the method and the system of managing the maintenance-part replacement timing interval of the present second embodiment, the replacement timing interval of the maintenance part replaced by the machine operating company in accordance with the use method of each machine of the company itself can be estimated on the machine manufacturing company side, and the demand for the maintenance part can be forecasted based on the estimation value at a high accuracy without excess or deficiency. In this manner, for the machine manufacturing company, it is only required to prepare a necessary amount of the maintenance part as many as required at required time, and therefore, stock management cost can be reduced.

When the method and the system of managing the maintenance-part replacement timing interval of the present second embodiment is used, the machine operating company employing a machine use method that has a high failure risk can be informed of an appropriate use method and maintenance-part replacement by checking the estimation value of the maintenance-part replacement timing interval and a designed standard so that they are matched, so that the risk of generation of non-working time of the machine can be reduced.

In the foregoing, the invention made by the present inventors has been concretely described based on the embodiments. However, it is needless to say that the present invention is not limited to the foregoing embodiments and various modification examples can be made within the scope of the present invention.

For example, the above-described embodiments have been explained for easily understanding the present invention, but are not always limited to the ones including all structures explained above. Also, a part of the structure of one embodiment can be replaced with the structure of the other embodiment, and besides, the structure of the other embodiment can be added to the structure of one embodiment. Further, the other structure can be added to/eliminated from/replaced with a part of the structure of each embodiment.

The target machines of the present invention are not limited to a specific machine, but include various machines provided with a time-dependently deteriorated maintenance part due to wearing or others as a component. For example, the machines include an engine generator, a turbine generator, an electric motor, a moving machine, a construction machine, a medical device, an elevator, a computer server device, a computer storage device, and a manufacturing apparatus.

The target areas of the present invention where the machine working conditions are similar to each other are not limited to the target areas sorted by a similar environment, but are applicable to target areas sorted by a similar intended use, target areas sorted by the machine operating company, or others.

### INDUSTRIAL APPLICABILITY

A method and a system of managing a replacement timing interval of a maintenance part of the present invention can be utilized in various machines provided with a time-dependently deteriorated maintenance part due to wearing or others as a component.

### SYMBOL EXPLANATION

11 part manufacturing line of machine manufacturing company
12 part warehouse of machine manufacturing company
13 maintenance-part accounting system of machine manufacturing company
14 network
20a, 20b, 20c machine operating company
21a machine
22a maintenance part
23a maintenance management system
24a communication unit
30 part list memory unit
31 area-name list memory unit
32 machine list memory unit
100 maintenance-part replacement timing interval management system of machine manufacturing company
101 calendar control unit
102a, 102b, 102c machine-basis demand forecast unit
103 area-basis demand forecast unit
104 demand-supply gap calculation unit
105 replacement time interval update unit
106 replacement time interval memory unit
107 machine working time information collection unit
108 machine working time information memory unit
109 maintenance-part supply history information collection unit
110 maintenance-part supply history information memory unit
111 area-basis supply count unit
600 machine-manufacturing-company operation center
601 maintenance-part replacement timing managing calculator
602 database (DB) managing calculator
610 computation processing device
620 memory device
630 memory device
640 input/output device

1. A method of managing a replacement timing interval of a maintenance part that forecasts, by a management system using a calculator, a demand for a maintenance part of a machine having the maintenance part, which is periodically replaced due to time-dependent deterioration as a component, comprising the steps of:
a machine working-time information collection step of collecting working time of each of a plurality of machines worked in target areas where machine working conditions are similar to each other, and of memorizing the working time in a machine working-time information memory unit;
a maintenance-part supply history information collection step of collecting an accumulated total number of actual maintenance-part supply of the maintenance part to the target area, and of memorizing the accumulated total number in a maintenance-part supply history information memory unit;
a demand forecast simulation step of calculating past part replacement timing of each machine in the target area from a maintenance-part replacement timing interval for which a tentative value is previously determined and from the working time memorized in the machine working-time information memory unit, and of counting and outputting an accumulated total number of past maintenance-part replacement demand of all the machines in time series;
a maintenance-part demand-supply gap calculation step of calculating and outputting a maintenance-part demand-supply gap value which is a difference between the time-series accumulated total number of maintenance-part replacement demand output in the demand forecast simulation step and the accumulated total number of the maintenance-part supply memorized in the maintenance-part supply history information memory unit; and
a maintenance-part replacement timing interval update step of calculating and outputting an optimum estimation value of the maintenance-part replacement timing interval which minimizes the maintenance-part demand-supply gap value output in the maintenance-part demand-supply gap calculation step while changing the tentative value of the maintenance-part replacement timing interval,
wherein a future demand for the maintenance part is forecasted by using the optimum estimation value of the maintenance-part replacement timing interval output in the maintenance-part replacement timing interval update step.

2. The method of managing the replacement timing interval of the maintenance part according to claim 1,
wherein the maintenance-part replacement timing interval is an individual value for each machine,
in the demand forecast simulation step, the past part replacement timing for each machine is calculated by using the part replacement timing interval for each of the machines, and the accumulated total number of the past maintenance-part replacement demand of all the machines in the target area is counted and output in time series,
in the maintenance-part demand-supply gap calculation step, the maintenance-part demand-supply gap value which is the difference between the accumulated total number of demand of the maintenance-part replacement in the target area output in the demand forecast simulation step and the accumulated total number of supply of the maintenance part supplied to the target area memorized in the maintenance-part supply history information memory unit is calculated and output, and,
in the maintenance-part replacement timing interval update step, the optimum estimation value of the maintenance-part replacement timing interval of each of the machines which minimizes the maintenance-part demand-supply gap value output in the maintenance-part demand-supply gap calculation step is calculated and output.

3. The method of managing the replacement timing interval of the maintenance part according to claim 2,
wherein, in the maintenance-part replacement timing interval update step, when the optimum estimation value of the maintenance-part replacement timing interval of each of the machines which minimizes the maintenance-part demand-supply gap value output in the maintenance-part demand-supply gap calculation step is calculated, the optimum estimation value of the maintenance-part replacement interval having such a time-series counted value as zero or as being minimized by cancelling positive and negative of a value at each point of the maintenance-part demand-supply gap value in time series is calculated.

4. The method of managing the replacement timing interval of the maintenance part according to claim 1,
wherein the target areas where the machine working conditions are similar to each other are target areas sorted by a similar environment, target areas sorted by a similar intended use, or target areas sorted by a machine operating company.

5. A system of managing a replacement timing interval of a maintenance part that forecasts, by a management system using a calculator, a demand for a maintenance part of a machine having the maintenance part, which is periodically replaced due to time-dependent deterioration, as a component, comprising:
a machine working time information collection unit that collects working time of each of a plurality of machines worked in target areas where machine operation conditions are similar to each other, and memorizes the working time in a machine working time information memory unit;
a maintenance-part supply history information collection unit that collects an accumulated total number of actual maintenance-part supply of the maintenance part for the target area, and memorizes the accumulated total number in a maintenance-part supply history information memory unit;
a demand forecast simulator unit that calculates past part replacement timing of each machine in the target area from a maintenance-part replacement timing interval for which a tentative value is previously determined and from the working time memorized in the machine working time information memory unit, and counts and outputs an accumulated total number of the past maintenance-part replacement demand of all the machines in time series;
a maintenance-part demand-supply gap calculation unit that calculates and outputs a maintenance-part demand-supply gap value which is a difference between the time-series accumulated total number of maintenance-part replacement demand output from the demand forecast simulator unit and the accumulated total number of maintenance-part supply memorized in the maintenance-part supply history information memory unit; and
a maintenance-part replacement timing interval update unit that calculates and outputs an optimum estimation value of the maintenance-part replacement timing interval which minimizes the maintenance-part demand-supply gap value output from the maintenance-part demand-supply gap calculation unit while changing the tentative value of the maintenance-part replacement timing interval,
wherein a future demand for the maintenance part is forecasted by using the optimum estimation value of the maintenance-part replacement timing interval output from the maintenance-part replacement timing interval update unit.

6. The system of managing the replacement timing interval of the maintenance part according to claim 5,
wherein the maintenance-part replacement timing interval is an individual value for each machine,
the demand forecast simulator unit calculates the past part replacement timing for each machine by using the part replacement timing interval for each of the machines, and counts and outputs the accumulated total number of the past maintenance-part replacement demand of all the machines in the target area in time series,
the maintenance-part demand-supply gap calculation unit calculates and outputs the maintenance-part demand-supply gap value which is a difference between the accumulated total number of demand of the maintenance-part replacement in the target area output in the demand forecast simulator unit and the accumulated total number of supply of the maintenance part supplied to the target area memorized in the maintenance-part supply history information memory unit, and
the maintenance-part replacement timing interval update unit calculates and outputs the optimum estimation value of the maintenance-part replacement timing interval of each of the machines which minimizes the maintenance-part demand-supply gap value output from the maintenance-part demand-supply gap calculation unit.

7. The system of managing the replacement timing interval of the maintenance part according to claim 6,
wherein, when the optimum estimation value of the maintenance-part replacement timing interval of each of the machines which minimizes the maintenance-part demand-supply gap value output from the maintenance-part demand-supply gap calculation unit is calculated, the maintenance-part replacement timing interval update unit calculates the optimum estimation value of the maintenance-part replacement interval having such a time-series counted value as zero or as being minimized by cancelling positive and negative of a value at each point of the maintenance-part demand-supply gap value in time series.

8. The system of managing the replacement timing interval of the maintenance part according to claim 5,
wherein the target areas where the machine working conditions are similar to each other are target areas sorted by a similar environment, target areas sorted by a similar intended use, or target areas sorted by a machine operating company.
